(19) United States
(12) Patent Application Publication
(10) Pub. No.: US 2025/0291618 A1
(43) Pub. Date: Sep. 18, 2025

(54) VIRTUALIZATION ACCELERATION IN DISPLAY PROCESSING

(71) Applicant: QUALCOMM Incorporated, San Diego, CA (US)

(72) Inventors: Sreekanth MODAIKKAL, Bangalore (IN); Abhijit Kumar GUPTA, Bangalore (IN); Gary Arthur CIAMBELLA, Newmarket (CA); Xian Chi Bobby MAN, Vaughan (CA); Kumar SAURABH, Bangalore (IN); Rohit KULKARNI, San Diego, CA (US); Anas ABU-ROMEH, Mississauga (CA); John Chi Kit WONG, Richmond Hill (CA)

(21) Appl. No.: 18/607,181

(22) Filed: Mar. 15, 2024

(51) Int. Cl. G06F 9/455; G06F 9/48; G06T 1/20

(52) U.S. Cl. CPC G06F 9/45558; G06F 9/4881; G06T 1/20

(57) ABSTRACT

Aspects presented herein relate to methods and devices for display processing including an apparatus, e.g., a DPU. The apparatus may configure a virtualization component for a set of workloads associated with a set of VMs. The apparatus may also execute the set of workloads associated with the set of VMs for a set of virtual queues. The apparatus may also perform at least one of: (1) a mapping of the set of VMs to the set of virtual queues, (2) a security check for an ability of each of the set of VMs to access a set of software registers, or (3) a mapping of each of the set of virtual queues to each of a set of control data paths.

### TECHNICAL FIELD

The present disclosure relates generally to processing systems and, more particularly, to one or more techniques for display processing applications.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor is configured to convert digital information received from a CPU to analog values and may issue commands to a display panel for displaying the visual content. A device that provides content for visual presentation on a display may utilize a GPU and/or a display processor.

A GPU of a device may be configured to perform the processes in a graphics processing pipeline. Further, a display processor or display processing unit (DPU) may be configured to perform the processes of display processing. However, with the advent of wireless communication and smaller, handheld devices, there has developed an increased need for improved graphics or display processing.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a client device, a server, a display processing unit (DPU), a graphics processing unit (GPU), or any apparatus that may perform display processing. The apparatus may obtain an indication of a set of workloads associated with a set of virtual machines (VMs); and store the set of workloads associated with the set of VMs in a set of virtual queues. The apparatus may also configure a virtualization component for a set of workloads associated with a set of virtual machines (VMs). Additionally, the apparatus may execute the set of workloads associated with the set of VMs for a set of virtual queues. The apparatus may also perform a security identifier (ID) check for each ID corresponding to each of the set of VMs, where the performance of the security ID check is based on the execution of the set of workloads. The apparatus may also determine whether access is granted for a retrieval of register data for each of the set of workloads; and retrieve the register data for each of the set of workloads associated with the set of VMs based on the access being granted. Moreover, the apparatus may perform at least one of: (1) a mapping of the set of VMs to the set of virtual queues, (2) a security check for an ability of each of the set of VMs to access a set of software registers, or (3) a mapping of each of the set of virtual queues to each of a set of control data paths. The apparatus may also determine whether access is granted for a configuration of software registers; and configure data for the software registers based on the access being granted. The apparatus may also determine whether the execution has reached a last workload in the set of workloads; and generate an interrupt for software based on the execution reaching the last workload. Also, the apparatus may generate a busy signal for each of the set of virtual queues and each of the set of control data paths; and map the busy signal for each of the set of virtual queues to the busy signal for each of the set of control data paths. The apparatus may also output an indication of the performance at least one of: (1) the mapping of the set of VMs to the set of virtual queues, (2) the security check for the ability of each of the set of VMs to access the set of software registers, or (3) the mapping of each of the set of virtual queues to each of the set of control data paths.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram that illustrates an example content generation system.

FIG. 2 illustrates an example graphics processing unit (GPU).

FIG. 3 illustrates an example display framework including a display processor and a display.

FIG. 4 is a diagram illustrating an example traditional architecture and an example virtual architecture.

FIG. 5 is a diagram illustrating an example virtualization architecture.

FIG. 6 is a diagram illustrating an example virtualization architecture.

FIG. 7 is a diagram illustrating an example virtualization architecture.

FIG. 8 is a diagram illustrating an example virtualization architecture.

FIG. 9 is a diagram illustrating an example virtualization architecture.

FIG. 10 is a diagram illustrating an example virtualization architecture.

FIG. 11 is a diagram illustrating an example mapping architecture.

FIG. 12 is a diagram illustrating an example virtualization architecture.

FIG. 13 is a diagram illustrating an example virtualization architecture.

FIG. 14 is a flowchart of an example method of display processing.

FIG. 15 is a communication flow diagram illustrating example communications between a DPU, a GPU/CPU, and a memory.

FIG. 16 is a flowchart of an example method of display processing.

FIG. 17 is a flowchart of an example method of display processing.

### DETAILED DESCRIPTION

Additionally, there may be a number of limitations to software-based virtualization implementations. For instance, for any virtual machine (VM) to communicate with the DPU hardware in order to configure its resources, the VM may need to communicate via the hypervisor. The hypervisor-based VM management may lead to large software latencies in order to configure the DPU hardware. Also, all of the security management amongst the VMs (which is carried out by the hypervisor software) may further add to the overall latency in the system. As the DPU hardware has limited and strict frame timelines, which if these timelines are missed, this may lead to a number of latency issues, such as janks (i.e., perceptible pauses in the smooth rendering of a software application's user interface) and underruns (i.e., a state occurring when a memory space is fed with data at a lower speed than the data is being read from it). Based on the above, it may be beneficial to provide VMs an optimized interface for hardware resources. It may also be beneficial to allow different numbers of VMs to control a different hardware data paths. Also, it may be beneficial to optimize an interrupt service routine (ISR) latency. It may also be beneficial to provide secure double data rate (DDR) access for VMs. Moreover, it may be beneficial to provide enhanced inter-VM security. Aspects of the present disclosure may provide novel software-based and hardware-based virtualization implementations.

Aspects of the present disclosure may include a number of benefits or advantages. For instance, aspects of the present disclosure may provide VMs a faster interface to configure their hardware resources to meet strict display frame timelines. Also, aspects presented herein may allow different numbers of VMs to control different hardware data paths. For example, aspects presented herein may allow multiple VMs to control a single hardware data path. Moreover, aspects presented herein may allow a single VM to control multiple hardware data paths. Also, aspects presented herein may optimize an overall ISR latency for each VM interrupt. Additionally, aspects presented herein may provide secure DDR access for each VM. Further, aspects presented herein may provide enhanced inter-VM security. That is, aspects presented herein may provide enhanced inter-VM security while configuring respective hardware resources by using a protection unit.

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOC), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software may be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application, i.e., software, being configured to perform one or more functions. In such examples, the application may be stored on a memory, e.g., on-chip memory of a processor, system memory, or any other memory. Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that may be used to store computer executable code in the form of instructions or data structures that may be accessed by a computer.

In general, this disclosure describes techniques for having a graphics processing pipeline in a single device or multiple devices, improving the rendering of graphical content, and/or reducing the load of a processing unit, i.e., any processing unit configured to perform one or more techniques described herein, such as a GPU. For example, this disclosure describes techniques for graphics processing in any device that utilizes graphics processing. Other example benefits are described throughout this disclosure.

As used herein, instances of the term “content” may refer to “graphical content,” “image,” and vice versa. This is true regardless of whether the terms are being used as an adjective, noun, or other parts of speech. In some examples, as used herein, the term “graphical content” may refer to a content produced by one or more processes of a graphics processing pipeline. In some examples, as used herein, the term “graphical content” may refer to a content produced by a processing unit configured to perform graphics processing. In some examples, as used herein, the term “graphical content” may refer to a content produced by a graphics processing unit.

In some examples, as used herein, the term “display content” may refer to content generated by a processing unit configured to perform displaying processing. In some examples, as used herein, the term “display content” may refer to content generated by a display processing unit. Graphical content may be processed to become display content. For example, a graphics processing unit may output graphical content, such as a frame, to a buffer (which may be referred to as a framebuffer). A display processing unit may read the graphical content, such as one or more frames from the buffer, and perform one or more display processing techniques thereon to generate display content. For example, a display processing unit may be configured to perform composition on one or more rendered layers to generate a frame. As another example, a display processing unit may be configured to compose, blend, or otherwise combine two or more layers together into a single frame. A display processing unit may be configured to perform scaling, e.g., upscaling or downscaling, on a frame. In some examples, a frame may refer to a layer. In other examples, a frame may refer to two or more layers that have already been blended together to form the frame, i.e., the frame includes two or more layers, and the frame that includes two or more layers may subsequently be blended.

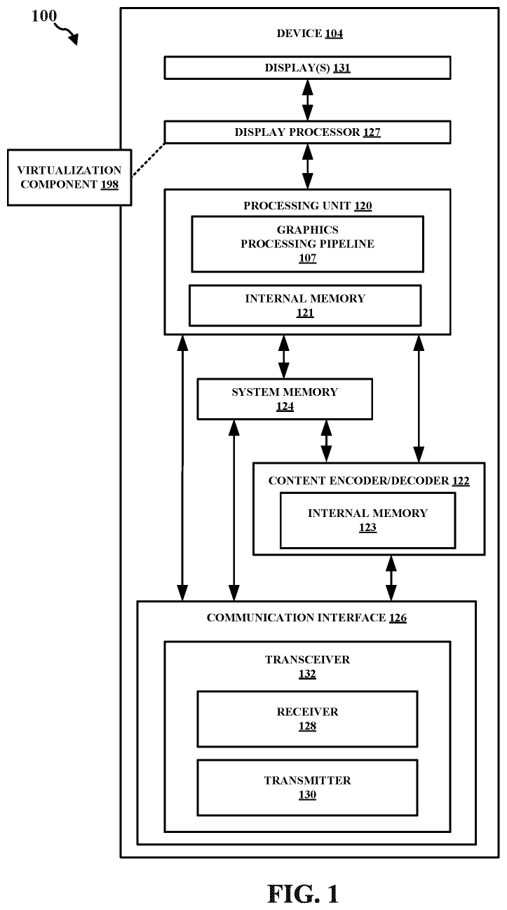

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of an SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components, e.g., a communication interface 126, a transceiver 132, a receiver 128, a transmitter 130, a display processor 127, and one or more displays 131. Reference to the display 131 may refer to the one or more displays 131. For example, the display 131 may include a single display or multiple displays. The display 131 may include a first display and a second display. The first display may be a left-eye display and the second display may be a right-eye display. In some examples, the first and second display may receive different frames for presentment thereon. In other examples, the first and second display may receive the same frames for presentment thereon. In further examples, the results of the graphics processing may not be displayed on the device, e.g., the first and second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing, such as in a graphics processing pipeline 107. The content encoder/decoder 122 may include an internal memory 123. In some examples, the device 104 may include a display processor, such as the display processor 127, to perform one or more display processing techniques on one or more frames generated by the processing unit 120 before presentment by the one or more displays 131. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of: a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 and the content encoder/decoder 122 may be communicatively coupled to the system memory 124 over a bus. In some examples, the processing unit 120 and the content encoder/decoder 122 may be communicatively coupled to each other over the bus or a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, SRAM, DRAM, erasable programmable ROM (EPROM), electrically erasable programmable ROM (EEPROM), flash memory, a magnetic data media or an optical storage media, or any other type of memory.

The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a central processing unit (CPU), a graphics processing unit (GPU), a general purpose GPU (GPGPU), or any other processing unit that may be configured to perform graphics processing. In some examples, the processing unit 120 may be integrated into a motherboard of the device 104. In some examples, the processing unit 120 may be present on a graphics card that is installed in a port in a motherboard of the device 104, or may be otherwise incorporated within a peripheral device configured to interoperate with the device 104. The processing unit 120 may include one or more processors, such as one or more microprocessors, GPUs, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the display processor 127 may include a virtualization component 198 configured to obtain an indication of a set of workloads associated with a set of virtual machines (VMs); and store the set of workloads associated with the set of VMs in a set of virtual queues. The virtualization component 198 may also be configured to configure a virtualization component for a set of workloads associated with a set of virtual machines (VMs). The virtualization component 198 may also be configured to execute the set of workloads associated with the set of VMs for a set of virtual queues. The virtualization component 198 may also be configured to a security identifier (ID) check for each ID corresponding to each of the set of VMs, where the performance of the security ID check is based on the execution of the set of workloads. The virtualization component 198 may also be configured to determine whether access is granted for a retrieval of register data for each of the set of workloads; and retrieve the register data for each of the set of workloads associated with the set of VMs based on the access being granted. The virtualization component 198 may also be configured to perform at least one of: (1) a mapping of the set of VMs to the set of virtual queues, (2) a security check for an ability of each of the set of VMs to access a set of software registers, or (3) a mapping of each of the set of virtual queues to each of a set of control data paths. The virtualization component 198 may also be configured to determine whether access is granted for a configuration of software registers; and configure data for the software registers based on the access being granted. The virtualization component 198 may also be configured to determine whether the execution has reached a last workload in the set of workloads; and generate an interrupt for software based on the execution reaching the last workload. The virtualization component 198 may also be configured to generate a busy signal for each of the set of virtual queues and each of the set of control data paths; and map the busy signal for each of the set of virtual queues to the busy signal for each of the set of control data paths. The virtualization component 198 may also be configured to output an indication of the performance at least one of: (1) the mapping of the set of VMs to the set of virtual queues, (2) the security check for the ability of each of the set of VMs to access the set of software registers, or (3) the mapping of each of the set of virtual queues to each of the set of control data paths. Although the following description may be focused on display processing, the concepts described herein may be applicable to other similar processing techniques.

As described herein, a device, such as the device 104, may refer to any device, apparatus, or system configured to perform one or more techniques described herein. For example, a device may be a server, a base station, user equipment, a client device, a station, an access point, a computer, e.g., a personal computer, a desktop computer, a laptop computer, a tablet computer, a computer workstation, or a mainframe computer, an end product, an apparatus, a phone, a smart phone, a server, a video game platform or console, a handheld device, e.g., a portable video game device or a personal digital assistant (PDA), a wearable computing device, e.g., a smart watch, an augmented reality device, or a virtual reality device, a non-wearable device, a display or display device, a television, a television set-top box, an intermediate network device, a digital media player, a video streaming device, a content streaming device, an in-car computer, any mobile device, any device configured to generate graphical content, or any device configured to perform one or more techniques described herein. Processes herein may be described as performed by a particular component (e.g., a GPU), but, in further embodiments, may be performed using other components (e.g., a CPU), consistent with disclosed embodiments.

GPUs may process multiple types of data or data packets in a GPU pipeline. For instance, in some aspects, a GPU may process two types of data or data packets, e.g., context register packets and draw call data. A context register packet may be a set of global state information, e.g., information regarding a global register, shading program, or constant data, which may regulate how a graphics context will be processed. For example, context register packets may include information regarding a color format. In some aspects of context register packets, there may be a bit that indicates which workload belongs to a context register. Also, there may be multiple functions or programming running at the same time and/or in parallel. For example, functions or programming may describe a certain operation, e.g., the color mode or color format. Accordingly, a context register may define multiple states of a GPU.

Context states may be utilized to determine how an individual processing unit functions, e.g., a vertex fetcher (VFD), a vertex shader (VS), a shader processor, or a geometry processor, and/or in what mode the processing unit functions. In order to do so, GPUs may use context registers and programming data. In some aspects, a GPU may generate a workload, e.g., a vertex or pixel workload, in the pipeline based on the context register definition of a mode or state. Certain processing units, e.g., a VFD, may use these states to determine certain functions, e.g., how a vertex is assembled. As these modes or states may change, GPUs may need to change the corresponding context. Additionally, the workload that corresponds to the mode or state may follow the changing mode or state.

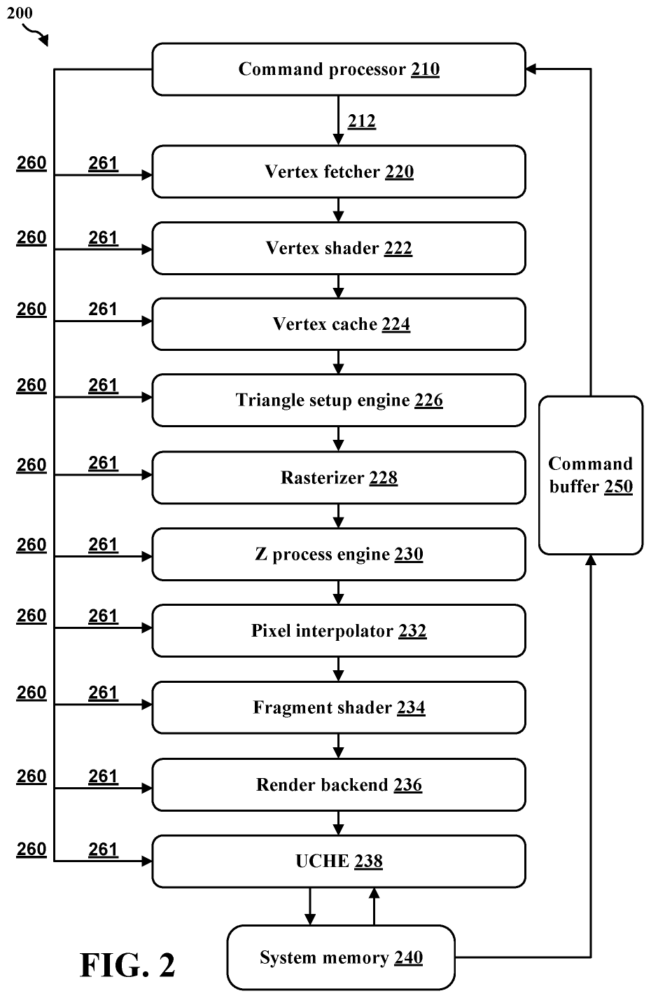

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, level 2 (L2) cache (UCHE) 238, and system memory 240. Although FIG. 2 displays that GPU 200 includes processing units 220-238, GPU 200 may include a number of additional processing units. Additionally, processing units 220-238 are merely an example and any combination or order of processing units may be used by GPUs according to the present disclosure. GPU 200 also includes command buffer 250, context register packets 260, and context states 261.

As shown in FIG. 2, a GPU may utilize a CP, e.g., CP 210, or hardware accelerator to parse a command buffer into context register packets, e.g., context register packets 260, and/or draw call data packets, e.g., draw call packets 212. The CP 210 may then send the context register packets 260 or draw call packets 212 through separate paths to the processing units or blocks in the GPU. Further, the command buffer 250 may alternate different states of context registers and draw calls. For example, a command buffer may be structured in the following manner: context register of context N, draw call(s) of context N, context register of context N+1, and draw call(s) of context N+1.

GPUs may render images in a variety of different ways. In some instances, GPUs may render an image using rendering and/or tiled rendering. In tiled rendering GPUs, an image may be divided or separated into different sections or tiles. After the division of the image, each section or tile may be rendered separately. Tiled rendering GPUs may divide computer graphics images into a grid format, such that each portion of the grid, i.e., a tile, is separately rendered. In some aspects, during a binning pass, an image may be divided into different bins or tiles. In some aspects, during the binning pass, a visibility stream may be constructed where visible primitives or draw calls may be identified. In contrast to tiled rendering, direct rendering does not divide the frame into smaller bins or tiles. Rather, in direct rendering, the entire frame is rendered at a single time. Additionally, some types of GPUs may allow for both tiled rendering and direct rendering.

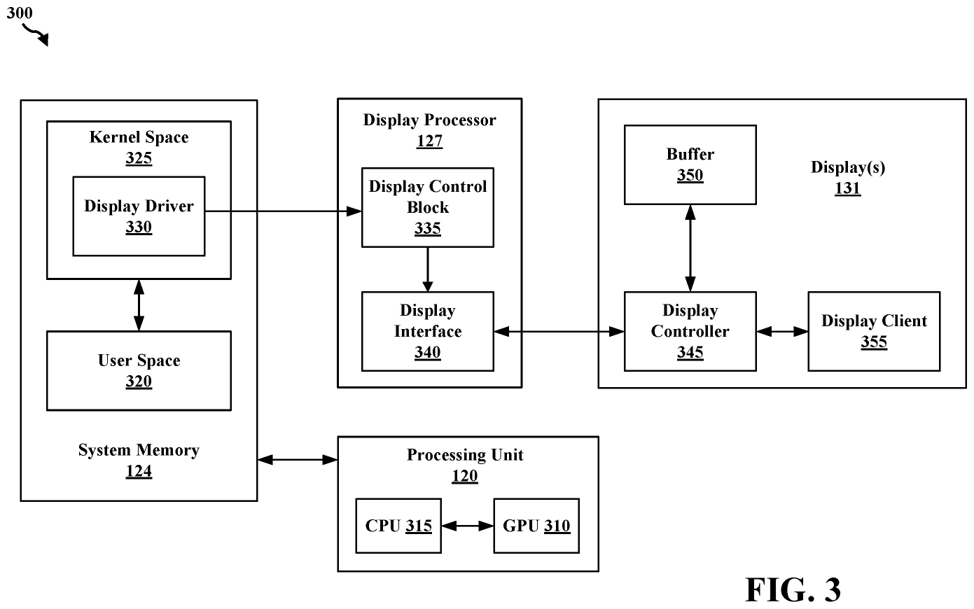

FIG. 3 is a block diagram 300 that illustrates an example display framework including the processing unit 120, the system memory 124, the display processor 127, and the display(s) 131, as may be identified in connection with the device 104.

A GPU may be included in devices that provide content for visual presentation on a display. For example, the processing unit 120 may include a GPU 310 configured to render graphical data for display on a computing device (e.g., the device 104), which may be a computer workstation, a mobile phone, a smartphone or other smart device, an embedded system, a personal computer, a tablet computer, a video game console, and the like. Operations of the GPU 310 may be controlled based on one or more graphics processing commands provided by a CPU 315. The CPU 315 may be configured to execute multiple applications concurrently. In some cases, each of the concurrently executed multiple applications may utilize the GPU 310 simultaneously. Processing techniques may be performed via the processing unit 120 output a frame over physical or wireless communication channels.

The system memory 124, which may be executed by the processing unit 120, may include a user space 320 and a kernel space 325. The user space 320 (sometimes referred to as an “application space”) may include software application(s) and/or application framework(s). For example, software application(s) may include operating systems, media applications, graphical applications, workspace applications, etc. Application framework(s) may include frameworks used by one or more software applications, such as libraries, services (e.g., display services, input services, etc.), application program interfaces (APIs), etc. The kernel space 325 may further include a display driver 330. The display driver 330 may be configured to control the display processor 127. For example, the display driver 330 may cause the display processor 127 to compose a frame and transmit the data for the frame to a display.

The display processor 127 includes a display control block 335 and a display interface 340. The display processor 127 may be configured to manipulate functions of the display(s) 131 (e.g., based on an input received from the display driver 330). The display control block 335 may be further configured to output image frames to the display(s) 131 via the display interface 340. In some examples, the display control block 335 may additionally or alternatively perform post-processing of image data provided based on execution of the system memory 124 by the processing unit 120.

The display interface 340 may be configured to cause the display(s) 131 to display image frames. The display interface 340 may output image data to the display(s) 131 according to an interface protocol, such as, for example, the MIPI DSI (Mobile Industry Processor Interface, Display Serial Interface). That is, the display(s) 131, may be configured in accordance with MIPI DSI standards. The MIPI DSI standard supports a video mode and a command mode. In examples where the display(s) 131 is/are operating in video mode, the display processor 127 may continuously refresh the graphical content of the display(s) 131. For example, the entire graphical content may be refreshed per refresh cycle (e.g., line-by-line). In examples where the display(s) 131 is/are operating in command mode, the display processor 127 may write the graphical content of a frame to a buffer 350.

In some such examples, the display processor 127 may not continuously refresh the graphical content of the display(s) 131. Instead, the display processor 127 may use a vertical synchronization (Vsync) pulse to coordinate rendering and consuming of graphical content at the buffer 350. For example, when a Vsync pulse is generated, the display processor 127 may output new graphical content to the buffer 350. Thus, generation of the Vsync pulse may indicate that current graphical content has been rendered at the buffer 350.

Frames are displayed at the display(s) 131 based on a display controller 345, a display client 355, and the buffer 350. The display controller 345 may receive image data from the display interface 340 and store the received image data in the buffer 350. In some examples, the display controller 345 may output the image data stored in the buffer 350 to the display client 355. Thus, the buffer 350 may represent a local memory to the display(s) 131. In some examples, the display controller 345 may output the image data received from the display interface 340 directly to the display client 355.

The display client 355 may be associated with a touch panel that senses interactions between a user and the display(s) 131. As the user interacts with the display(s) 131, one or more sensors in the touch panel may output signals to the display controller 345 that indicate which of the one or more sensors have sensor activity, a duration of the sensor activity, an applied pressure to the one or more sensor, etc. The display controller 345 may use the sensor outputs to determine a manner in which the user has interacted with the display(s) 131. The display(s) 131 may be further associated with/include other devices, such as a camera, a microphone, and/or a speaker, that operate in connection with the display client 355.

Some processing techniques of the device 104 may be performed over three stages (e.g., stage 1: a rendering stage; stage 2: a composition stage; and stage 3: a display/transfer stage). However, other processing techniques may combine the composition stage and the display/transfer stage into a single stage, such that the processing technique may be executed based on two total stages (e.g., stage 1: the rendering stage; and stage 2: the composition/display/transfer stage). During the rendering stage, the GPU 310 may process a content buffer based on execution of an application that generates content on a pixel-by-pixel basis. During the composition and display stage(s), pixel elements may be assembled to form a frame that is transferred to a physical display panel/subsystem (e.g., the displays 131) that displays the frame.

Instructions executed by a CPU (e.g., software instructions) or a display processor may cause the CPU or the display processor to search for and/or generate a composition strategy for composing a frame based on a dynamic priority and runtime statistics associated with one or more composition strategy groups. A frame to be displayed by a physical display device, such as a display panel, may include a plurality of layers. Also, composition of the frame may be based on combining the plurality of layers into the frame (e.g., based on a frame buffer). After the plurality of layers are combined into the frame, the frame may be provided to the display panel for display thereon. The process of combining each of the plurality of layers into the frame may be referred to as composition, frame composition, a composition procedure, a composition process, or the like.

A frame composition procedure or composition strategy may correspond to a technique for composing different layers of the plurality of layers into a single frame. The plurality of layers may be stored in doubled data rate (DDR) memory. Each layer of the plurality of layers may further correspond to a separate buffer. A composer or hardware composer (HWC) associated with a block or function may determine an input of each layer/buffer and perform the frame composition procedure to generate an output indicative of a composed frame. That is, the input may be the layers and the output may be a frame composition procedure for composing the frame to be displayed on the display panel.

In some aspects, a display device may present frames at different frame rates on the first display panel and the second display panel. For instance, a display panel may present frames at 60 frames per second (FPS) on both the first display panel and the second display panel, 45 FPS on both the first display panel and the second display panel, etc. The display device may synchronize frame rates of content with refresh rates of the display panels (via a vertical synchronization process, which may be referred to as vsync, Vsync, VSync, or VSYNC). For instance, content may be available at 60 FPS and the first display panel and the second display panel may have a refresh rate of 95 Hz. Via Vsync, the refresh rate of the first display panel and the second display panel may be set to 60 Hz to match the 60 FPS content.

As indicated herein, VSync is a graphics technology that synchronizes the frame rate of an application/game with a refresh rate at a display (e.g., a display on a client device). Vsync may be utilized as a manner in which to deal with screen tearing (i.e., the screen displays portions of multiple frames at once). That can result in the display appearing to be split along a line. Tearing may occur when the display refresh rate (i.e., how many times the display updates per second) is not in synchronization with the frames per second (FPS). VSync signals may synchronize the display pipeline (e.g., the pipeline including application rendering, compositor, and a hardware composer (HWC) that presents images on the display). For instance, VSync signals may help to synchronize the time in which applications wake up to start rendering, the time the compositor wakes up to composite the screen, and the display refresh cycle. This synchronization may help to eliminate display refresh issues and improve visual performance. In some examples, the HWC may generates VSync events/signals and send the events/signals to the compositor.

Virtualization is a process of creating a software-based representation or virtual representation of something (e.g., virtual applications, servers, storage, and networks). For instance, virtualization may be the act of creating a virtual version of something at a certain abstraction level, such as virtual computer hardware platforms, storage devices, and/or computer network resources. In some instances, virtualization may allow the creation of virtual representations of servers, storage, networks, and other physical machines. Virtual software (SW) may also mimic the functions of physical hardware (HW) in order to run multiple virtual machines simultaneously on a single physical machine. In a virtualized architecture there may be multiple operating systems (OSs) running in parallel on a single underlying physical hardware. The software (i.e., the hypervisor) may create an abstraction layer over the physical hardware that allows the hardware elements to be divided into various virtual computers, called virtual machines (VMs). The hypervisor may also manage the resource allocation amongst all of the VMs, as well as manage the security.

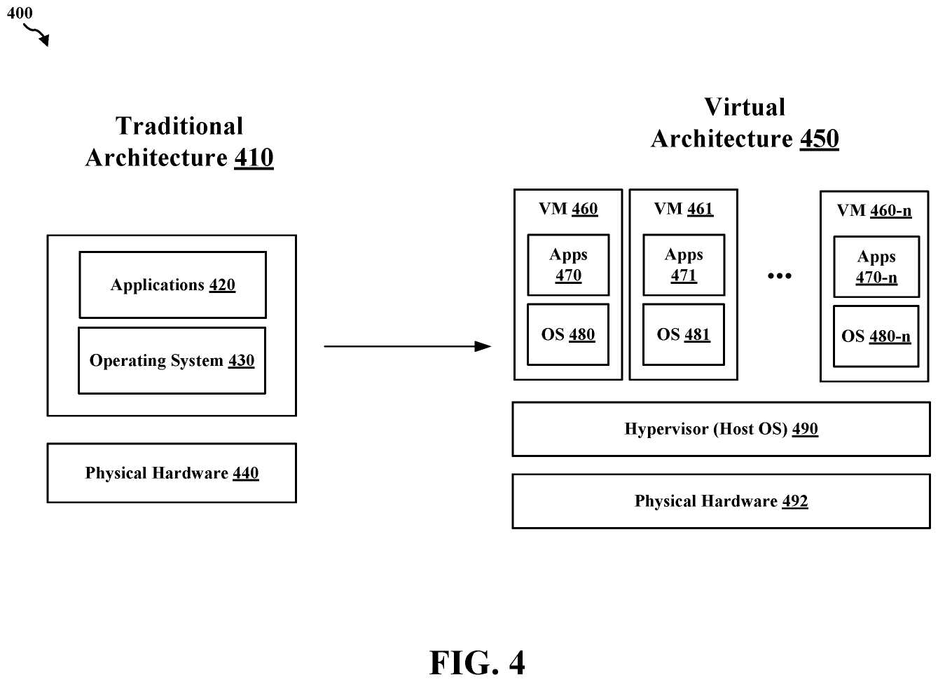

FIG. 4 illustrates diagram 400 including one example of different architectures. More specifically, diagram 400 depicts traditional architecture and a virtual architecture. As shown in FIG. 4, diagram 400 includes traditional architecture 410 including applications 420, operating system 430, and physical hardware 440. Also, diagram 400 includes virtual architecture 450 including VM 460, VM 461, VM 460-n, applications 470, applications 471, applications 470-n, operating system 480, operating system 481, operating system 480-n, hypervisor 490 (e.g., host OS), and physical hardware 492. FIG. 4 depicts that virtual architecture 450 allows multiple VMs the ability to work concurrently on a single underlying physical hardware 492. The hypervisor 490 may be responsible for allocating and deallocating the resources of the physical hardware 492 to the different VMs that are running on it, as well as manage the security amongst the VMs.

Virtualization may be utilized in a number of different scenarios. For instance, virtualization may be utilized in automotive systems. In automotive systems, there may be a number of different displays present. Each of the displays may be controlled by individual virtual machines (VMs) running on separate operating systems (OSs). Also, a hypervisor (HOST-OS) may be responsible for resource allocation among different VMs. Additionally, all of the OSs may be running on a single underlying hardware (e.g., a DPU hardware).

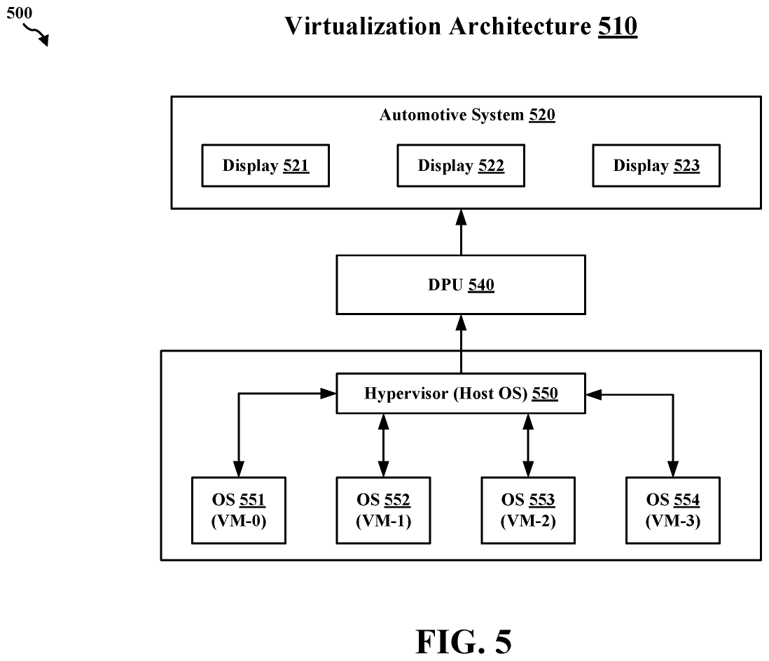

FIG. 5 illustrates diagram 500 including one example of an architecture. More specifically, diagram 500 depicts a virtualization architecture for an automotive system and a display processing unit (DPU). As shown in FIG. 5, diagram 500 includes virtualization architecture 510 including automotive system 520 (with display 521, display 522, and display 523), DPU 540, hypervisor 550 (host OS), OS 551 (corresponding to VM-0), OS 552 (corresponding to VM-1), OS 553 (corresponding to VM-2), and OS 554 (corresponding to VM-3). FIG. 5 depicts that there may be multiple displays in automotive system 520 and each of the displays may be controlled by a given OS or VM. The displays may correspond to different aspects of the automotive system. For example, display 521 may correspond to the car dashboard, display 522 may correspond to a navigation component, and display 523 may correspond to an in-car infotainment system. Also, the automotive system 520 may include a number of different applications. As shown in FIG. 5, each of the VMs may be running on the software end and they may be interacting on our DPU hardware with the help of the hypervisor, which is also running on the software and managing the resources among the VMs, as well as the security amongst them.

There may be a number of different types of virtualization implementations. For instance, there may be a software-based virtualization implementation where there are multiple VMs are running in parallel. In a software-based virtualization implementation, the hypervisor software may manage the DPU hardware resources to be shared among each VM. Also, the hypervisor software may be responsible for managing the security amongst each of the VMs. Also, there may be latency issues within software-based virtualization implementations. For example, in the example shown in FIG. 5, there may be latency issues between each of the VMs and the hypervisor. That is, there may be latency issues between the hypervisor 550 (host OS) and each of the OSs, such as OS 551 (corresponding to VM-0), OS 552 (corresponding to VM-1), OS 553 (corresponding to VM-2), and OS 554 (corresponding to VM-3). Also, there may be latency issues between the hypervisor 550 (host OS) and the DPU 540.

Moreover, there are a number of different hardware-based virtualization challenges. For instance, there may be issues with inter-VM security in hardware-based virtualization. In a multi-VM environment, each VM may handle an individual display. Each VM may have a dedicated set of hardware resources in its data path. Also, a compromised VM may interfere with the data path of other VMs leading to frame corruption. For example, a data path for a first VM (VM-1) may interfere with a data path for a second VM (VM-2). Further, certain types of data may be corrupted (e.g., the navigation frame data may be corrupted). There is a challenge to provide inter-VM security, such that no VM will interfere with other VMs operation.

Also, there may be issues between mapping from multiple VMs to multiple control (CTL) paths. A control path may define a hardware data path which has a set of hardware resources associated with it. A VM may be able to configure the hardware resources mapped to a control path. Thus, there may be a way to map any VM to any control path. However, there may not be the ability for multiple VMs to be mapped to any control path. Accordingly, one challenge may be to provide the ability for multiple VMs to be mapped to any control path.

In some aspects, there may be optimization for interrupt management per VM and interrupt service routine (ISR) latency. For instance, each VM may generate the interrupts for the resources it owns. Also, the ISR latency to service the interrupt may be optimized. As the number of VM scales, the overall latency may impact the display performance. Further, there may be a secure double data rate (DDR) memory access per VM. Each VM may handle a memory client that wants to access the data from DDR memory. A compromised VM may try to access the DDR data of another VM, which may lead to snooping of data and security concerns. There is a challenge to provide means to each VM to securely access the register data from DDR.

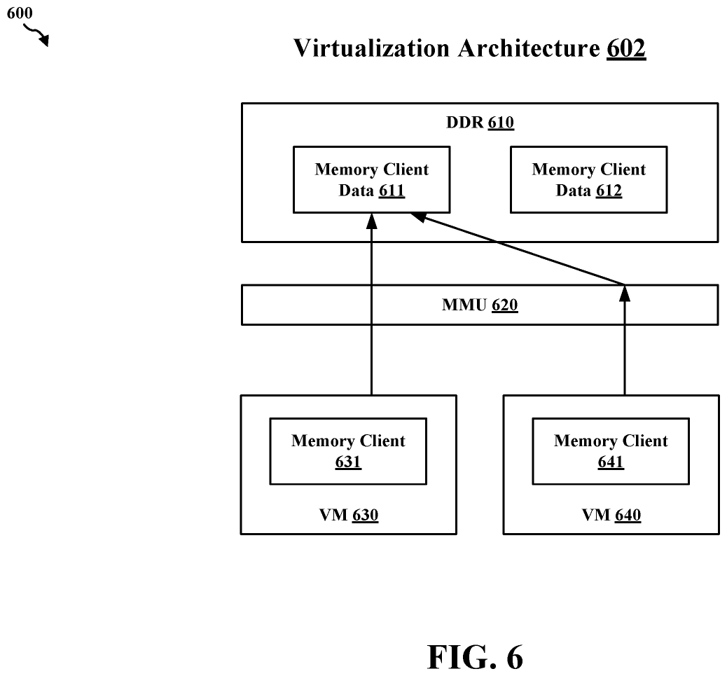

FIG. 6 illustrates diagram 600 including one example of an architecture. More specifically, diagram 600 depicts a virtualization architecture 602. As shown in FIG. 6, virtualization architecture 602 includes DDR 610 including memory client data 611 and memory client data 612, memory management unit (MMU) 620, VM 630, memory client 631, VM 640, and memory client 641. FIG. 6 depicts that both VM 630 and VM 640 attempt to fetch the address of memory client data 611. Accordingly, VM 640 is corrupted and incorrectly attempts to fetch the address of memory client data 611, rather than fetch the address of memory client data 612. That is, VM 640 is compromised and may snoop the data of VM 630 by programming the DDR access address in its register space. Indeed, a compromised VM 640 may try to access the DDR data of VM 630, which may lead to snooping of data and security concerns. As such, there is a challenge to provide means to each VM to securely access the register data from DDR.

As indicated herein, a display processing unit (DPU) in a chip can work in a virtualized environment where there are multiple VMs handling multiple displays/regions of display concurrently while working on a single underlying DPU hardware. This scenario may be commonly observed in automotive use-cases where there are multiple displays to be driven in parallel. With software-based virtualization implementation, one challenge lies in configuring the DPU hardware resources owned by respective VMs in a limited display frame time. This is taken care by hypervisor (host VM) where it interacts with all the other VMs to allocate them DPU hardware resources as well as maintaining the security between them. Since all the resource allocation and security is completely handled in software side, there can be huge impact on overall latencies leading to frame janks and underrun issues.

Additionally, there may be a number of limitations to software-based virtualization implementations. For instance, for any VM to communicate with the DPU hardware in order to configure its resources, the VM may need to communicate via the hypervisor. The hypervisor-based VM management may lead to large software latencies in order to configure the DPU hardware. Also, all of the security management amongst the VMs (which is carried out by the hypervisor software) may further add to the overall latency in the system. As the DPU hardware has limited and strict frame timelines, which if these timelines are missed, this may lead to a number of latency issues, such as janks (i.e., perceptible pauses in the smooth rendering of a software application's user interface) and underruns (i.e., a state occurring when a memory space is fed with data at a lower speed than the data is being read from it). Based on the above, it may be beneficial to provide VMs an optimized interface for hardware resources. It may also be beneficial to allow different numbers of VMs to control a different hardware data paths. Also, it may be beneficial to optimize an ISR latency. It may also be beneficial to provide secure DDR access for VMs. Moreover, it may be beneficial to provide enhanced inter-VM security.

Aspects of the present disclosure may provide novel software-based and hardware-based virtualization implementations. For instance, aspects of the present disclosure may provide VMs a faster interface to configure their hardware resources. This may allow VMs to meet strict display frame timelines. Also, aspects presented herein may allow different numbers of VMs to control different hardware data paths. For example, aspects presented herein may allow multiple VMs to control a single hardware data path. Moreover, aspects presented herein may allow a single VM to control multiple hardware data paths. Also, aspects presented herein may optimize an overall ISR latency for each VM interrupt. Additionally, aspects presented herein may provide secure DDR access for each VM. Further, aspects presented herein may provide enhanced inter-VM security. That is, aspects presented herein may provide enhanced inter-VM security while configuring respective hardware resources.

Aspects presented herein may relate to DPUs that can work in a virtualized environment where there are multiple VMs running in parallel with the underlying DPU hardware. As indicated above, one challenge is configuring the DPU hardware resources for the VMs in a limited display frame time. This is performed by the hypervisor (host VM) in order to allocate the DPU hardware resources, as well as to maintain security. Because resource allocation and security may be handled in software, there may be a huge impact on overall latencies, which leads to frame janks and underrun issues. This leads to implementing the virtualization in DPU hardware which poses its own challenges like handling the inter-VM security, secure data access, interrupt management, etc. Aspects presented herein propose an ability to provide VMs a faster interface to configure their hardware resources to meet the limited display frame timeline. Aspects presented herein also propose an ability to support multiple VMs to be able to control a single HW data path, support a single VM to be able to control a multiple HW data paths, optimize the overall ISR latency for each VM interrupt, provide secure DDR access for each VM, and provide the inter-VM security while configuring respective hardware resources (e.g., by using protection unit).

Additionally, aspects presented herein may utilize a hardware-based virtualization implementation. For instance, aspects presented herein may utilize a virtualization implementation at DPU hardware. In the hardware-based virtualization, each VM may directly interact with DPU hardware to configure the resources it is assigned. The hypervisor may interact directly with DPU hardware to define the reservation of each VM for different DPU hardware resources. The hypervisor may also handle the security amongst each of the VMs. So the hypervisor may directly interact with the DPU hardware to define the permissions and handle the resource management among the VMs. All of these operations occur within the DPU hardware itself, so the entire latency may be optimized and, thus, multiple VMs may be incorporated with an increasing number of use cases. Aspects presented herein may also utilize a virtualization accelerator, which may be used as a register configuration accelerator engine for the DPU. Further, the interaction between the VM and hypervisor (host OS) may be significantly minimized which leads to a latency optimization for the overall configuration.

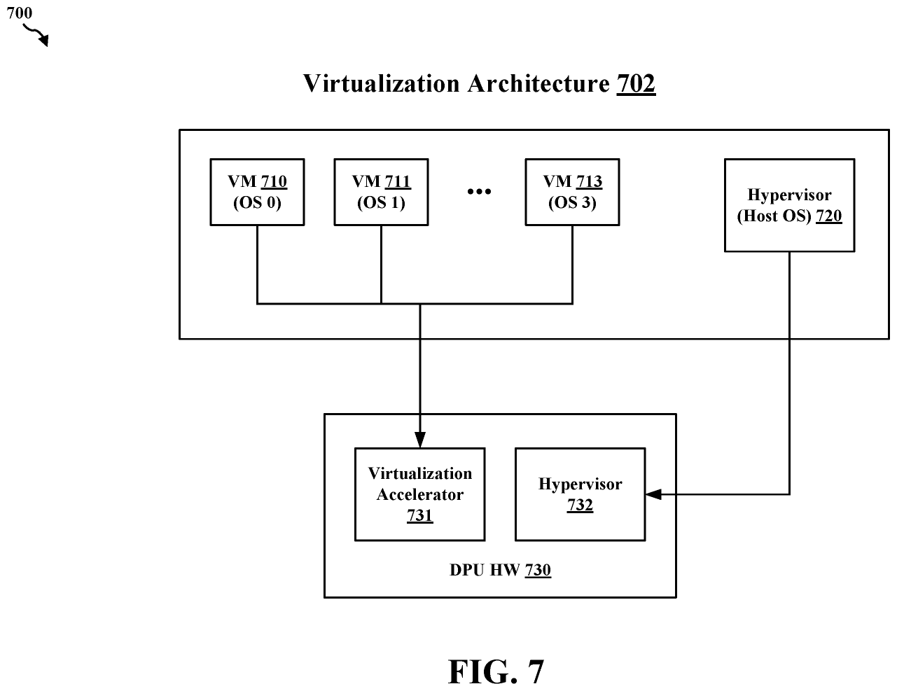

FIG. 7 illustrates diagram 700 including one example of an architecture. More specifically, diagram 700 depicts a virtualization architecture 702. As shown in FIG. 7, virtualization architecture 702 includes VM 710 (i.e., OS 0), VM 711 (i.e., OS 1), VM 713 (i.e., OS 3), hypervisor 720 (host OS). Virtualization architecture 702 also includes DPU hardware 730 including virtualization accelerator 731 and hypervisor 732. FIG. 7 depicts that each of the VMs (VM 710, VM 711, VM 713, etc.) may communicate with virtualization accelerator 731 in DPU hardware 730. Also, hypervisor 720 may communicate with hypervisor 732 in DPU hardware 730. As shown in FIG. 7, the hypervisor 720 may directly interact with the DPU hardware 730 to define the permissions and handle the resource management amongst the VMs (VM 710, VM 711, VM 713, etc.). Each of these operations may occur within the DPU hardware 730, so the entire latency may be optimized and multiple VMs (VM 710, VM 711, VM 713, etc.) may be incorporated with an increasing number of use cases. Also, the virtualization accelerator 731 may be used as a register configuration accelerator engine for the DPU hardware 730. Further, the interaction between the VMs (VM 710, VM 711, VM 713, etc.) and hypervisor 732 (host OS) may be significantly minimized which results in a latency optimization.

In some instances, aspects presented herein may introduce a virtualization accelerator block. This virtualization accelerator block may be used as a configuration accelerator for GPU registers. Also, this is an accelerator is because it uses a faster interface to directly fetch the registered data from the DDR to configure the registers for each of the VMs. So this virtualization accelerator block may enable the DPU hardware to support multiple VMs. There are multiple virtual queues (VQs) within the accelerator block and corresponding to each queue there are VW registers to which any VM can push their workloads.

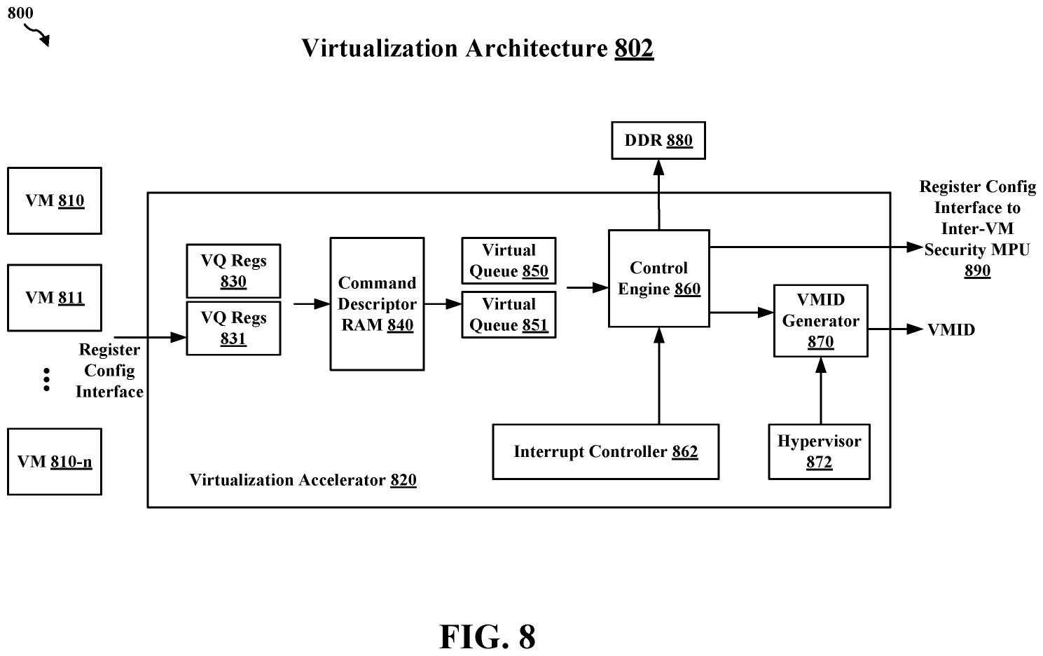

FIG. 8 illustrates diagram 800 including one example of an architecture. More specifically, diagram 800 depicts a virtualization architecture 802. As shown in FIG. 8, virtualization architecture 802 includes VM 810, VM 811, VM 810-n, and DDR 880. Virtualization architecture 802 also includes virtualization accelerator 820 including VQ register 830, VQ register 831, command descriptor random access memory (RAM) 840, virtual queue 850, virtual queue 851, control engine 860, interrupt controller 862, virtual machine identifier (VMID) generator 870, and hypervisor 872. FIG. 8 depicts that the register configuration interface may be sent to VQ register 830 and VQ register 831, which may then communicate with command descriptor RAM 840, and then virtual queue 850 and virtual queue 851. The virtual queues may then communicate with control engine 860, which may receive communication from interrupt controller 862 (which may perform an interrupt generation per VQ) and transmit communication to DDR 880. Also, control engine 860 may output the register configuration interface to an inter-VM security memory protection unit (MPU) 890. The control engine 860 may transmit to VMID generator 870, which may receive communication from hypervisor 872, and then output a VMID.

As depicted in FIG. 8, the virtualization accelerator 820 may be a configuration accelerator for configuring DPU registers. That is, the virtualization accelerator 820 may be a configuration accelerator as it is faster than a regular bus. Also, the virtualization accelerator 820 utilizes a fast Advanced extensible Interface (AXI) to fetch software register data. There may be “n” number of virtual queues in the virtualization accelerator 820 hardware. This may allow the VM to configure the registers for the resources that they own by programming their workload in a separately-allocated VQ registers (e.g., 4 kB page per VQ). Also, the virtualization accelerator 820 may generate per-VQ interrupts upon completion of respective workloads.

Also, as depicted in FIG. 8, each of the VMs (e.g., VM 810, VM 811, VM 810-n) can push their workload in any of the virtual queues (VQs). Also, the inter-VM security MPU 890 may utilize a VMID associated with every register access transaction. Further, a new VMID generator 870 is added to issue a VM ID (VMID) for every register access. The VMID generator 870 may be a mapper between the virtual queue, which is a term for the virtualization accelerator IP to the VMID which may be used to grant or deny the permission for a particular workload. This mapping may be defined in the virtualization hypervisor space. Also, a new set of registers are added in the hypervisor 872 as shown that maps the VQ ID to the VMID. This register space is under control of the hypervisor 872.

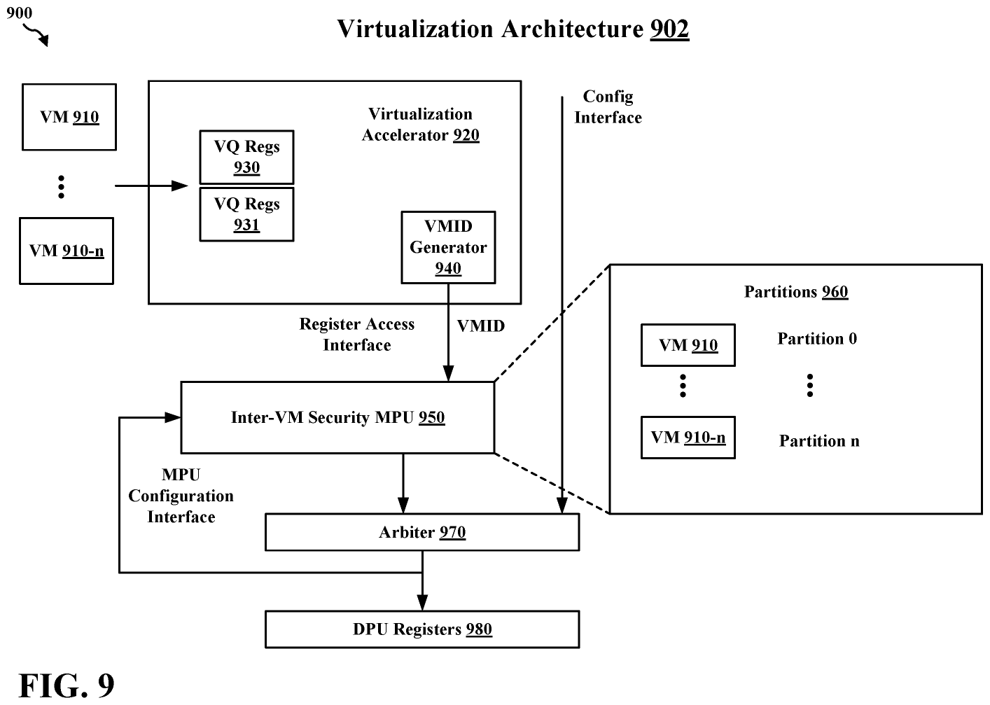

FIG. 9 illustrates diagram 900 including one example of an architecture. More specifically, diagram 900 depicts a virtualization architecture 902 with a security block. As shown in FIG. 9, virtualization architecture 902 includes several VMs including VM 910 and VM 910-n, inter-VM security MPU 950, partitions 960, arbiter 970, and DPU registers 980. Virtualization architecture 902 also includes virtualization accelerator 920 including VQ register 930, VQ register 931, and VMID generator 940. FIG. 9 depicts that VM 910 and VM 910-n communicate with VQ register 930 and VQ register 931. VMID generator 940 sends a VMID to inter-VM security MPU 950, which can also receive a MPU configuration interface from arbiter 970. Arbiter 970 can also receive a configuration interface, as well as communicate with DPU registers 980. Also, inter-VM security MPU 950 may utilize partitions 960, where the VMs are partitioned.

As depicted in FIG. 9, the incoming address from virtualization accelerator 920 is checked against all partitions to figure out which partition we are trying to access. The VMID of that transaction is checked against the permission defined for the matching partition. The inter-VM security MPU 950 is added to provide security among the VMs trying to access the register space for each partition (e.g., 4 kB partition). Also, the read/write permission is defined for each partition (e.g., 4 kB partition) for each VM. For instance, the hypervisor (host OS) may define the read/write permissions for each VM for each of the partitions. A compromised VM trying to access the resources/partition meant for other VMs may result in an error transaction and will be communicated back to host OS.

In some aspects, the inter-VM security MPU may deny certain VMs access to certain addresses. For instance, a certain VM (e.g., VM 6) may attempt to access a certain address range, such as an address range that falls under a certain partition (e.g., partition 2). If this partition (e.g., partition 2) just allows access to a certain VM (e.g., VM 5), then the inter-VM security MPU may deny access to an address. For example, partition 2 may just allow VM 5 to access its address, so VM 6 may be denied access here by the inter-VM security MPU. For the MPU transaction, access to a specific address may be granted for a certain VM (e.g., VM 5) and access to the specific address may be denied for other VMs (e.g., VM 6).

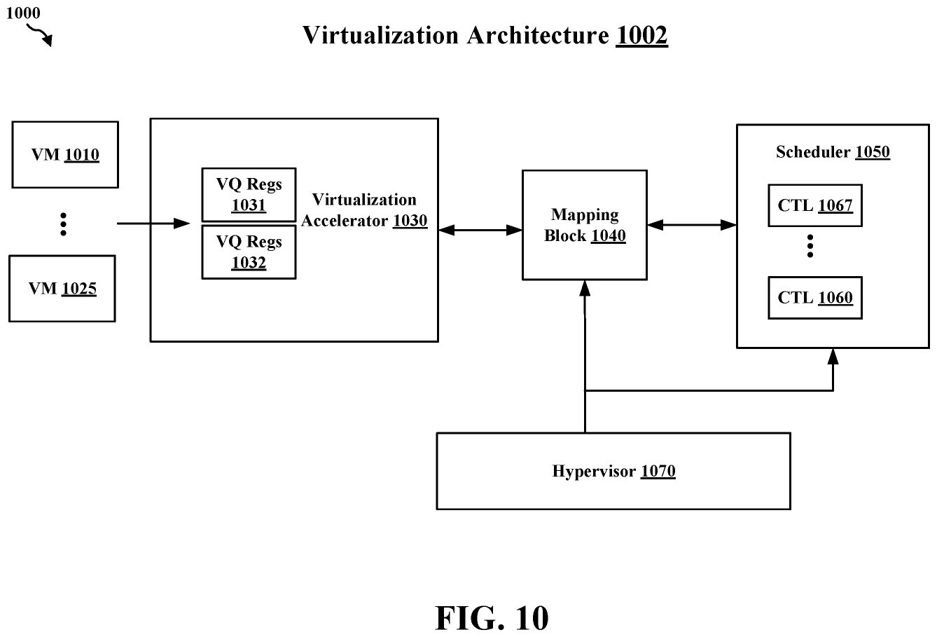

FIG. 10 illustrates diagram 1000 including one example of an architecture. More specifically, diagram 1000 depicts a virtualization architecture 1002 with a mapping block. As shown in FIG. 10, virtualization architecture 1002 includes several VMs including VM 1010 and VM 1025, mapping block 1040, hypervisor 1070, and scheduler 1050 including control path 1060 to control path 1067. Virtualization architecture 1002 also includes virtualization accelerator 1030 including VQ register 1031 and VQ register 1032. FIG. 10 depicts that VM 1010 and VM 1025 may communicate with VQ register 1031 and VQ register 1032, which may communicate with mapping block 1040. Also, mapping block 1040 may receive communication from hypervisor 1070, as well as communicate with scheduler 1050. FIG. 10 illustrates a mapping support for multiple VMs to control blocks. As shown in FIG. 10, scheduler 1050 may be responsible to allocate hardware resources for each CTL path (e.g., control path 1060 to control path 1067). A new mapping block 1040 may be added that maps all the VQ-based signals from virtualization accelerator 1030 to the scheduler 1050, which is CTL based. Also, the registers of hypervisor 1070 may define the set of VQs that are mapped to each CTL path. This is programmed by the hypervisor software (host OS). With this design update, any number of VQs can be mapped to any CTL path.

Additionally, there may be a new set of registers added in hypervisor space (e.g., hypervisor 1070) which is consumed by a VQ-to-CTL mapping block (e.g., mapping block 1040). That is, certain VQs may be mapped to certain CTL paths. For example, VQ 2 may be mapped to CTL path 0, and VQ 3 may be mapped to CTL path 1. In some instances, a busy signal from virtualization accelerator 1030 may define when a particular VQ is busy with executing its workload. This is consumed by hardware for scheduler 1050 to determine if the next frame may be kicked off or not based on busy signal.

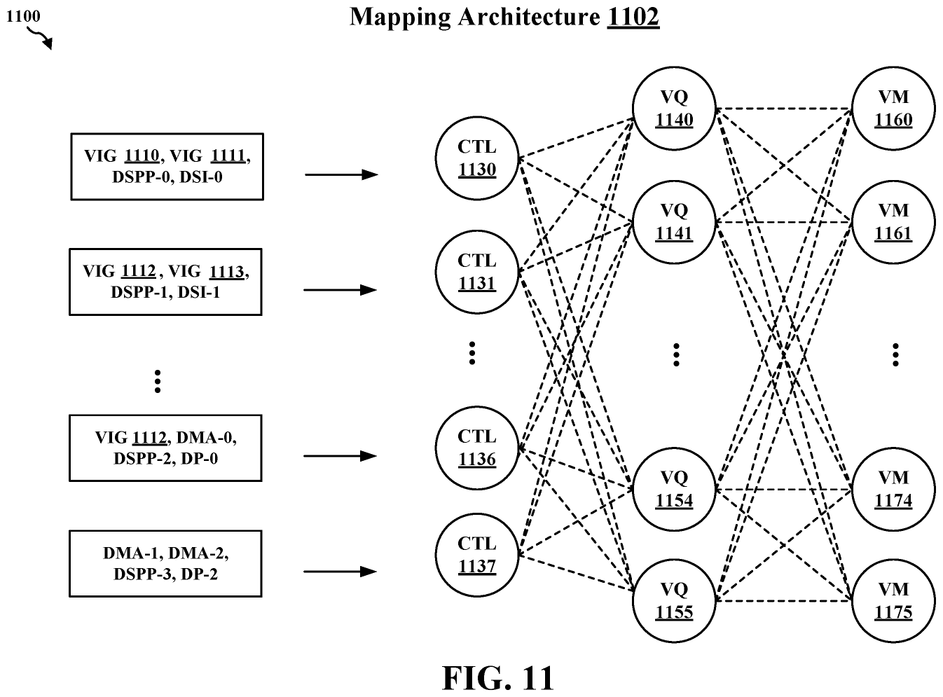

FIG. 11 illustrates diagram 1100 including one example of an architecture. More specifically, diagram 1100 depicts a mapping architecture 1102. As shown in FIG. 11, diagram 1100 includes video engine (VIG) 1110, VIG 1111, digital signal post-processing (DSPP) zero (DSPP-O), display serial interface (DSI) zero (DSI-0), VIG 1112, VIG 1113, DSPP-1, DSI-1, direct memory access (DMA) zero (DMA-0), DSPP-2, display processor (DP) zero (DP-0), DMA-1, DSPP-3, and DP-2. FIG. 11 also includes CTL path 1130, CTL path 1131, CTL path 1136, CTL path 1137, VQ 1140, VQ 1141, VQ 1154, VQ 1155, VM 1160, VM 1161, VM 1174, and VM 1175. FIG. 11 depicts how different VMs can push their workloads to any of the virtual queues in the virtualization accelerator (Vir_ACC) hardware. The VQ are then mapped to CTL path in the scheduler based on reservation/mapping defined in hypervisor space.

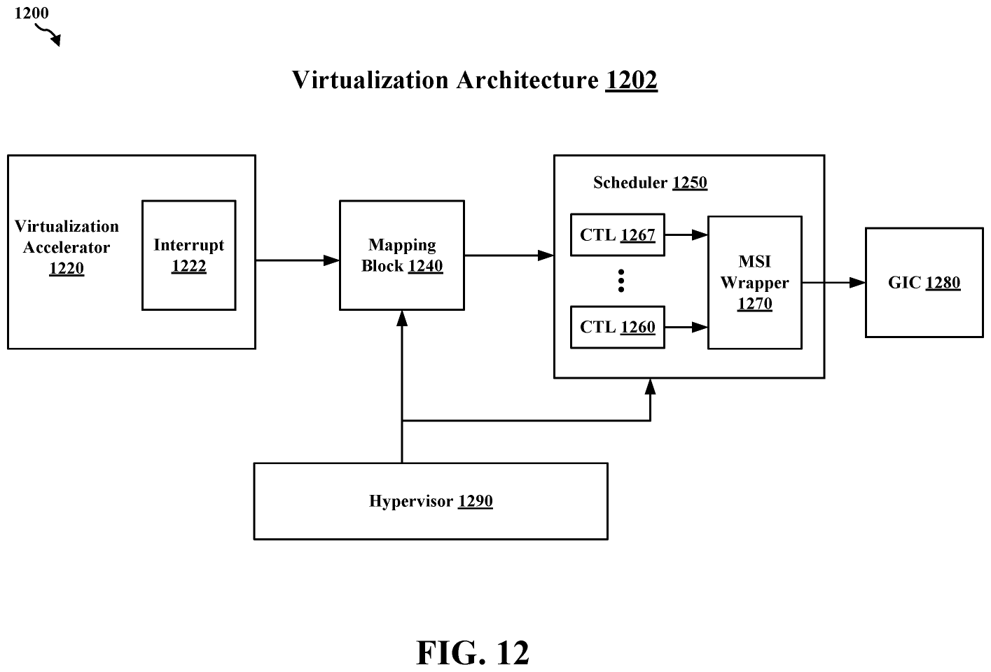

FIG. 12 illustrates diagram 1200 including one example of an architecture. More specifically, diagram 1200 depicts a virtualization architecture 1202 with a mapping block. As shown in FIG. 12, virtualization architecture 1202 includes virtualization accelerator 1220 including interrupt 1222, mapping block 1240, hypervisor 1290, scheduler 1250 including control path 1260 to control path 1267 and message signal-based interrupt (MSI) wrapper 1270, and global interrupt controller (GIC) 1280. FIG. 12 depicts an interrupt management scheme that is utilize per VQ. The virtualization accelerator 1220 may generate an interrupt upon completion of each VQ workload. Also, the mapping block 1240 may generate per CTL interrupt from per VQ interrupt by using mapping defined in the hypervisor 1290 register space. The MSI controller may provide a means to route CTL interrupts (translated from VQ) to the GIC 1280. As shown in FIG. 12, MSI-based interrupt routing may be faster than line-based interrupt, and thus optimizes overall ISR latency to service all the VMs interrupts.

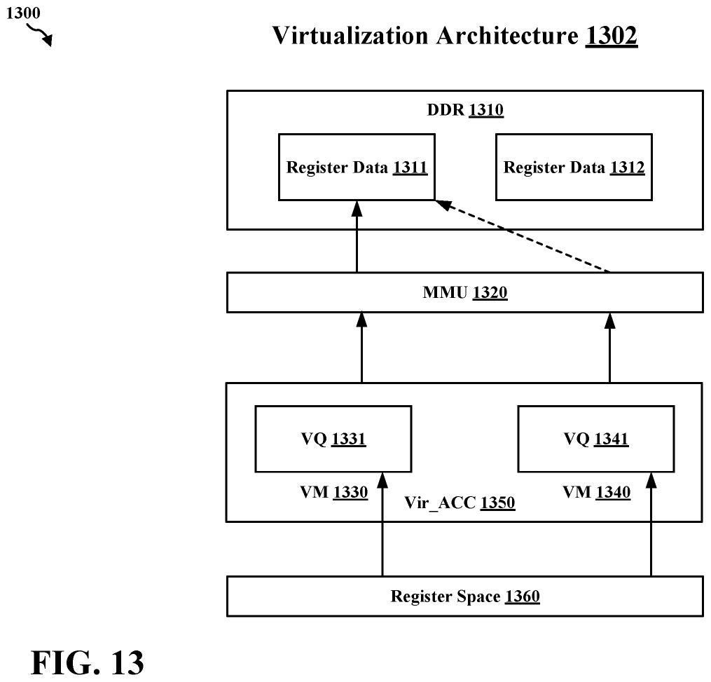

FIG. 13 illustrates diagram 1300 including one example of an architecture. More specifically, diagram 1300 depicts a virtualization architecture 1302. As shown in FIG. 13, diagram 1300 includes DDR 1310 including register data 1311 and register data 1312, memory management unit (MMU) 1320, and register space 1360. FIG. 13 also illustrates virtualization accelerator 1350 including VM 1330, VQ 1331, VM 1340, and VQ 1341. FIG. 13 depicts that VM 1340 is compromised and hence VQ 1341 tries to access register data 1312. However, this access is blocked by MMU 1320. For example, MMU 1320 blocks the access of VQ 1341 to register data 1312 after checking its security ID (SID) against the address range permitted to that SID. As shown in FIG. 13, a new SID register space may be introduced which is programmed by the secure hypervisor (host OS). The SID or security ID defines an ID for each VMs resource that can access the data from DDR (i.e., memory client). The MMU 1320 may handle the DDR access based on the SID where it has the knowledge of the address range permissible for each SID.

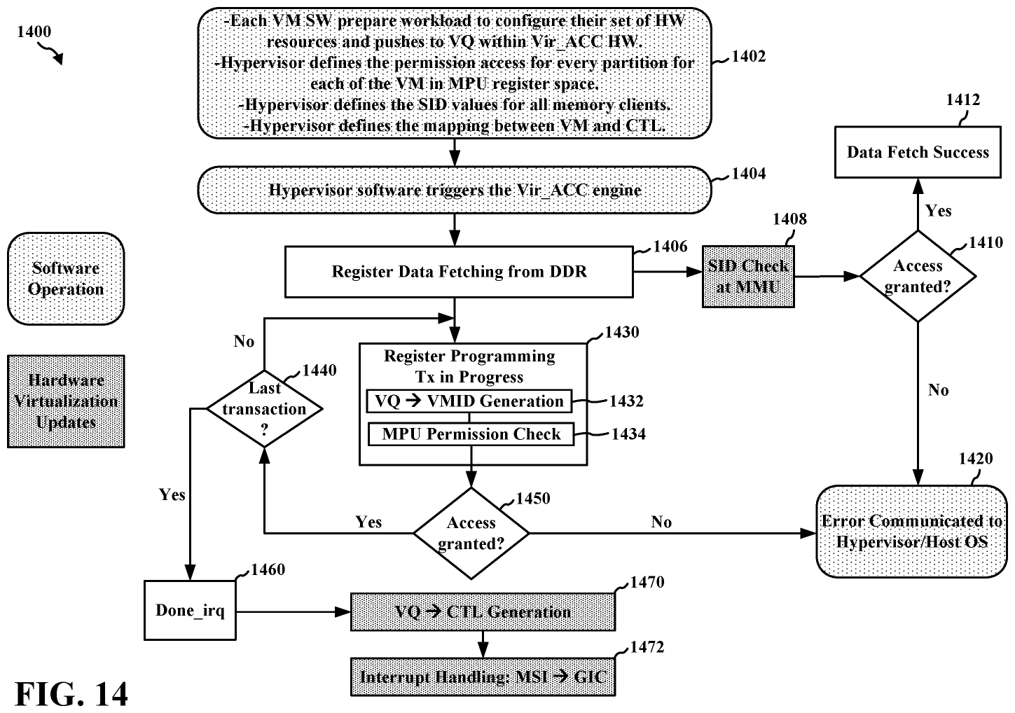

FIG. 14 illustrates diagram 1400 including one example of flowchart. More specifically, diagram 1400 depicts a flowchart for display processing. FIG. 14 depicts a number of different operations for display processing including software operations and hardware virtualization updates. At 1402, each VM software may prepare a workload to configure their set of hardware resources and pushes to VQ within Vir_ACC hardware. Also, at 1402, the hypervisor may define the permission access for every partition for each of the VM in MPU register space. The hypervisor may define the SID values for all memory clients, and the hypervisor may define the mapping between VM and the CTL path. At 1404, the hypervisor software may trigger the Vir_ACC engine. At 1406, there is register data fetching from DDR. At 1408, there is a SID check at the MMU. At 1410, there is a determination of whether access is granted. If yes at 1410, at 1412, there is data fetch success. If no at 1410, at 1420, the error is communicated to the hypervisor. At 1430, there is a register programming transmission in progress including a VQ to VMID generation at 1432 and a MPU permission check at 1434. At 1450, there is a determination of whether access is granted. If no at 1450, the error is communicated to the hypervisor. If yes at 1450, at 1440, there is a determination of whether this is a last transaction. If no at 1440, the decision goes back to 1430. If yes at 1440, the process proceeds to 1460 for the interrupt request (IRQ). At 1470, there is a VQ to CTL path generation. At 1472, there is an interrupt handling (e.g., MSI to GIC).

In some aspects, there may be different types of VMs that are mapped to different control paths. Aspects presented herein may utilize a multiple VM to single CTL path scenario, where multiple VMs are mapped to a single CTL path. Here, each VM may configure their workload in a separate VQ in VIR_ACC. Each VMs workload may be assigned a unique VMID which is sent to the MPU. The MPU may then grant access based on permission defined for that VMID for the partition it is trying to access. Upon completion of the VQ workload, the IRQ is generated which may then be mapped to a CTL path based on the mapping defined between the VQ and CTL path.

Additionally, aspects presented herein may utilize a single VM to multiple CTL path scenario, where a single VM is mapped to multiple CTL paths. In this scenario, the VM may configure its workload in separate VQ in Vir_ACC. The VMs workload may be assigned a unique VMID which is sent to the MPU. Here, the same VMID may be assigned to all VQ workloads since a single VM is handling multiple VQs. Also, the MPU may grant access based on permission defined for that VMID for the partition it is trying to access. Upon completion of VQ workload, an IRQ is generated which may then be mapped to a CTL path based on the mapping defined between the VQ and CTL path.

Aspects of the present disclosure may include a number of benefits or advantages. For instance, aspects of the present disclosure may provide VMs a faster interface to configure their hardware resources to meet strict display frame timelines. Also, aspects presented herein may allow different numbers of VMs to control different hardware data paths. For example, aspects presented herein may allow multiple VMs to control a single hardware data path. Moreover, aspects presented herein may allow a single VM to control multiple hardware data paths. Also, aspects presented herein may optimize an overall ISR latency for each VM interrupt. Additionally, aspects presented herein may provide secure DDR access for each VM. Further, aspects presented herein may provide enhanced inter-VM security. That is, aspects presented herein may provide enhanced inter-VM security while configuring respective hardware resources by using a protection unit.

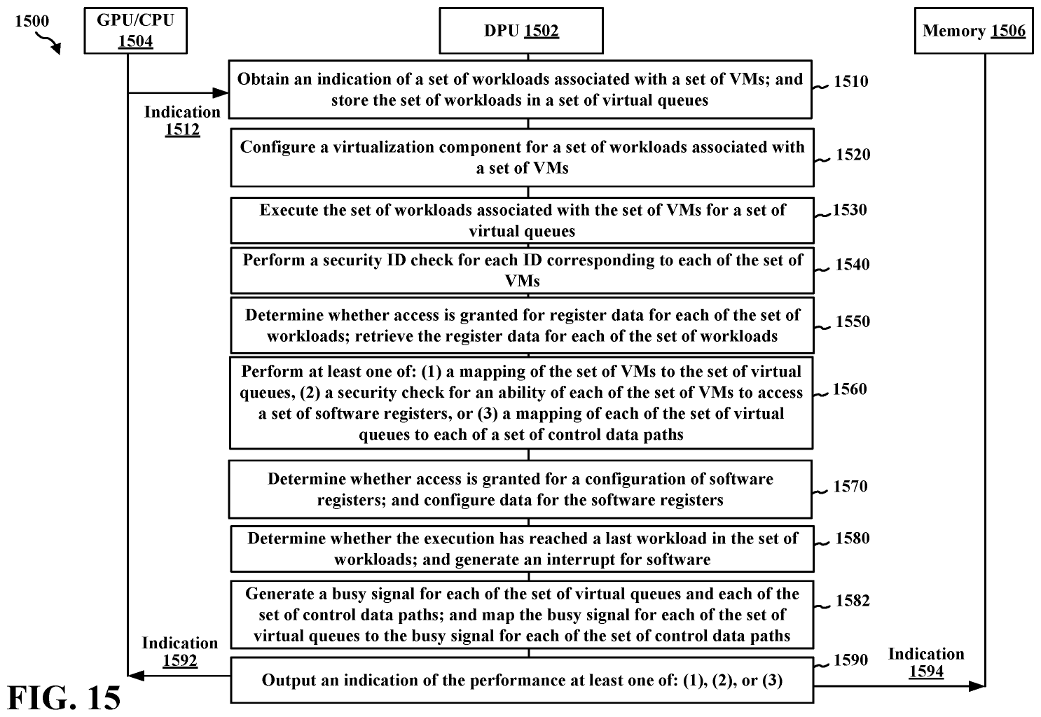

FIG. 15 is a communication flow diagram 1500 of display processing in accordance with one or more techniques of this disclosure. As shown in FIG. 15, diagram 1500 includes example communications between DPU 1502 (e.g., DPU or other display processor, a CPU or other central processor, a DPU driver, a display driver integrated circuit (DDIC), a GPU or other graphics processor), GPU/CPU 1504 (e.g., a GPU, a CPU, a DPU, or other display processing device), and memory 1506 (e.g., a memory or a cache), in accordance with one or more techniques of this disclosure.

At 1510, DPU 1502 may obtain an indication of a set of workloads associated with a set of virtual machines (VMs) (e.g., DPU 1502 may obtain indication 1512 from GPU/CPU 1504); and store the set of workloads associated with the set of VMs in a set of virtual queues. The DPU may also obtain an indication to start an execution of the set of workloads associated with the set of VMs for the set of virtual queues.

At 1520, DPU 1502 may configure a virtualization component (e.g., accelerator) for a set of workloads associated with a set of virtual machines (VMs). Configuring the virtualization component may comprise: configuring a mapping table for the mapping of the set of VMs to the set of virtual queues. Further, configuring the virtualization component may comprise: configuring the mapping for each of the set of virtual queues to each of the set of control data paths.

At 1530, DPU 1502 may execute the set of workloads associated with the set of VMs for a set of virtual queues.

At 1540, DPU 1502 may perform a security identifier (ID) check for each ID corresponding to each of the set of VMs, where the performance of the security ID check is based on the execution of the set of workloads. In some aspects, performing the security ID check may comprise performing the security ID check at a memory management unit (MMU). Also, the security ID check may include at least one failure. The DPU may also communicate the at least one failure of the security ID check to software (e.g., hypervisor).

At 1550, DPU 1502 may determine whether access is granted for a retrieval of register data for each of the set of workloads; and retrieve the register data for each of the set of workloads associated with the set of VMs based on the access being granted. The register data may include information for configuring software registers at a display processing unit (DPU). The register data may include a virtual identifier (ID) associated with each of the set of virtual queues. Also, retrieving the register data may comprise: retrieving the register data from a double data rate (DDR) memory after a security identifier (ID) check.

At 1560, DPU 1502 may perform at least one of: (1) a mapping of the set of VMs to the set of virtual queues, (2) a security check for an ability of each of the set of VMs to access a set of software registers, or (3) a mapping of each of the set of virtual queues to each of a set of control data paths. In some aspects, each of the set of control data paths may include hardware that is used to perform a set of display processing operations. The set of display processing operations may include at least one of: fetching image data from a double data rate (DDR) memory; performing pixel processing; or communicating the pixel processing to a display panel. Also, performing the mapping of the set of VMs to the set of virtual queues may comprise: performing the mapping of the set of VMs to the set of virtual queues based on a mapping table for the mapping of the set of VMs to the set of virtual queues (e.g., VQ to VMID generation). In some aspects, performing the security check may comprise: performing the security check regarding whether each of the set of VMs is able to access the set of software registers (e.g., a memory protection unit (MPU) permission check).

At 1570, DPU 1502 may determine whether access is granted for a configuration of software registers; and configure data for the software registers based on the access being granted. The data may include control information for data processing of a display processing unit (DPU).

At 1580, DPU 1502 may determine whether the execution has reached a last workload in the set of workloads; and generate an interrupt for software based on the execution reaching the last workload. In some aspects, the interrupt may include information regarding which VM in the set of VMs triggered the generation of the interrupt.

At 1582, DPU 1502 may generate a busy signal for each of the set of virtual queues and each of the set of control data paths; and map the busy signal for each of the set of virtual queues to the busy signal for each of the set of control data paths. The DPU may also initiate each of a set of display processing operations based on the generation of the busy signal for each of the set of virtual queues and each of the set of control data paths.

At 1590, DPU 1502 may output an indication of the performance at least one of: (1) the mapping of the set of VMs to the set of virtual queues, (2) the security check for the ability of each of the set of VMs to access the set of software registers, or (3) the mapping of each of the set of virtual queues to each of the set of control data paths. In some aspects, outputting the indication of the performance may comprise: transmitting the indication of the performance (e.g., DPU 1502 may transmit indication 1592 to GPU/CPU 1504); or storing the indication of the performance (e.g., DPU 1502 may store indication 1594 to memory 1506).

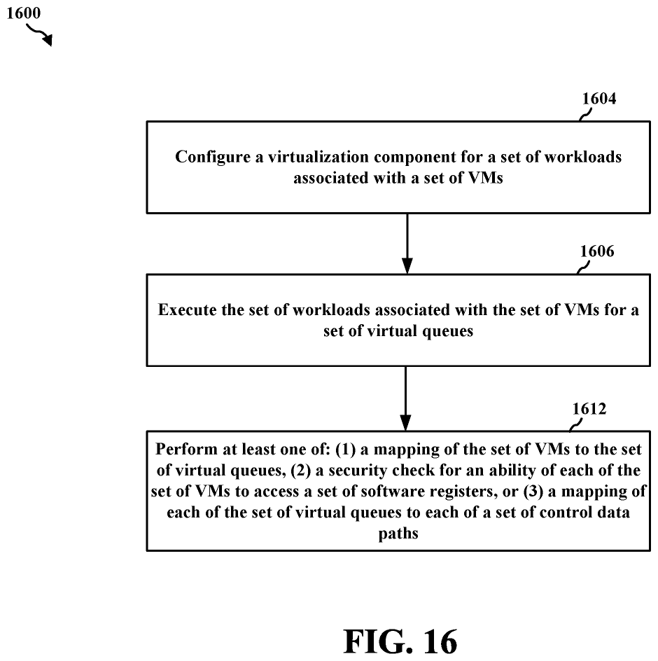

FIG. 16 is a flowchart 1600 of an example method of display processing in accordance with one or more techniques of this disclosure. The method may be performed by a DPU (or other display processor), a CPU (or other central processor), a DPU driver, a DDIC, a GPU (or other graphics processor), an apparatus for display processing, a wireless communication device, and/or any apparatus that may perform display processing as used in connection with the examples of FIGS. 1-15.

At 1604, the DPU may configure a virtualization component for a set of workloads associated with a set of virtual machines (VMs), as described in connection with the examples in FIGS. 1-15. For example, as described in 1520 of FIG. 15, DPU 1502 may configure a virtualization component for a set of workloads associated with a set of virtual machines (VMs). Further, step 1604 may be performed by display processor 127 in FIG. 1. Configuring the virtualization component may comprise: configuring a mapping table for the mapping of the set of VMs to the set of virtual queues. Further, configuring the virtualization component may comprise: configuring the mapping for each of the set of virtual queues to each of the set of control data paths.

At 1606, the DPU may execute the set of workloads associated with the set of VMs for a set of virtual queues, as described in connection with the examples in FIGS. 1-15. For example, as described in 1530 of FIG. 15, DPU 1502 may execute the set of workloads associated with the set of VMs for a set of virtual queues. Further, step 1606 may be performed by display processor 127 in FIG. 1.

At 1612, the DPU may perform at least one of: (1) a mapping of the set of VMs to the set of virtual queues, (2) a security check for an ability of each of the set of VMs to access a set of software registers, or (3) a mapping of each of the set of virtual queues to each of a set of control data paths, as described in connection with the examples in FIGS. 1-15. For example, as described in 1560 of FIG. 15, DPU 1502 may perform at least one of: (1) a mapping of the set of VMs to the set of virtual queues, (2) a security check for an ability of each of the set of VMs to access a set of software registers, or (3) a mapping of each of the set of virtual queues to each of a set of control data paths. Further, step 1612 may be performed by display processor 127 in FIG. 1. In some aspects, each of the set of control data paths may include hardware that is used to perform a set of display processing operations. The set of display processing operations may include at least one of: fetching image data from a double data rate (DDR) memory; performing pixel processing; or communicating the pixel processing to a display panel. Also, performing the mapping of the set of VMs to the set of virtual queues may comprise: performing the mapping of the set of VMs to the set of virtual queues based on a mapping table for the mapping of the set of VMs to the set of virtual queues (e.g., VQ to VMID generation). In some aspects, performing the security check may comprise: performing the security check regarding whether each of the set of VMs is able to access the set of software registers (e.g., a memory protection unit (MPU) permission check).

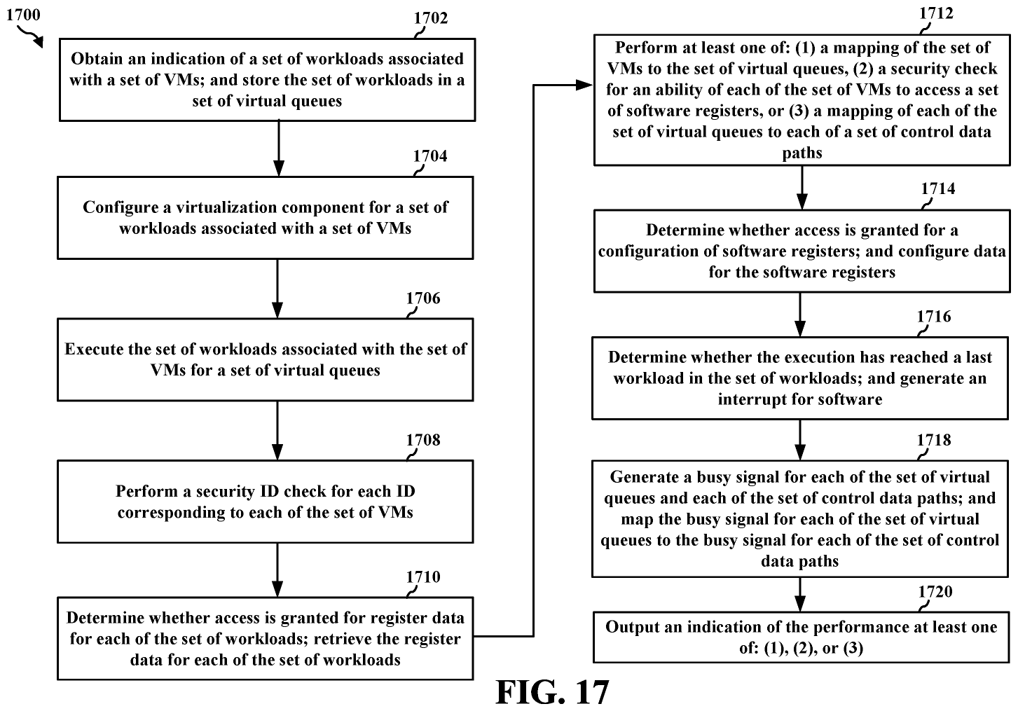

FIG. 17 is a flowchart 1700 of an example method of display processing in accordance with one or more techniques of this disclosure. The method may be performed by a DPU (or other display processor), a CPU (or other central processor), a DPU driver, a DDIC, a GPU (or other graphics processor), an apparatus for display processing, a wireless communication device, and/or any apparatus that may perform display processing as used in connection with the examples of FIGS. 1-15.

At 1702, the DPU may obtain an indication of a set of workloads associated with a set of virtual machines (VMs); and store the set of workloads associated with the set of VMs in a set of virtual queues, as described in connection with the examples in FIGS. 1-15. For example, as described in 1510 of FIG. 15, DPU 1502 may obtain an indication of a set of workloads associated with a set of virtual machines (VMs); and store the set of workloads associated with the set of VMs in a set of virtual queues. Further, step 1702 may be performed by display processor 127 in FIG. 1. The DPU may also obtain an indication to start an execution of the set of workloads associated with the set of VMs for the set of virtual queues.

At 1704, the DPU may configure a virtualization component for a set of workloads associated with a set of virtual machines (VMs), as described in connection with the examples in FIGS. 1-15. For example, as described in 1520 of FIG. 15, DPU 1502 may configure a virtualization component for a set of workloads associated with a set of virtual machines (VMs). Further, step 1704 may be performed by display processor 127 in FIG. 1. Configuring the virtualization component may comprise: configuring a mapping table for the mapping of the set of VMs to the set of virtual queues. Further, configuring the virtualization component may comprise: configuring the mapping for each of the set of virtual queues to each of the set of control data paths.

At 1706, the DPU may execute the set of workloads associated with the set of VMs for a set of virtual queues, as described in connection with the examples in FIGS. 1-15. For example, as described in 1530 of FIG. 15, DPU 1502 may execute the set of workloads associated with the set of VMs for a set of virtual queues. Further, step 1706 may be performed by display processor 127 in FIG. 1.

At 1708, the DPU may perform a security identifier (ID) check for each ID corresponding to each of the set of VMs, where the performance of the security ID check is based on the execution of the set of workloads, as described in connection with the examples in FIGS. 1-15. For example, as described in 1540 of FIG. 15, DPU 1502 may perform a security identifier (ID) check for each ID corresponding to each of the set of VMs, where the performance of the security ID check is based on the execution of the set of workloads. Further, step 1708 may be performed by display processor 127 in FIG. 1. In some aspects, performing the security ID check may comprise performing the security ID check at a memory management unit (MMU). Also, the security ID check may include at least one failure. The DPU may also communicate the at least one failure of the security ID check to software (e.g., hypervisor).

At 1710, the DPU may determine whether access is granted for a retrieval of register data for each of the set of workloads; and retrieve the register data for each of the set of workloads associated with the set of VMs based on the access being granted, as described in connection with the examples in FIGS. 1-15. For example, as described in 1550 of FIG. 15, DPU 1502 may determine whether access is granted for a retrieval of register data for each of the set of workloads; and retrieve the register data for each of the set of workloads associated with the set of VMs based on the access being granted. Further, step 1710 may be performed by display processor 127 in FIG. 1. The register data may include information for configuring software registers at a display processing unit (DPU). The register data may include a virtual identifier (ID) associated with each of the set of virtual queues. Also, retrieving the register data may comprise: retrieving the register data from a double data rate (DDR) memory after a security identifier (ID) check.

At 1712, the DPU may perform at least one of: (1) a mapping of the set of VMs to the set of virtual queues, (2) a security check for an ability of each of the set of VMs to access a set of software registers, or (3) a mapping of each of the set of virtual queues to each of a set of control data paths, as described in connection with the examples in FIGS. 1-15. For example, as described in 1560 of FIG. 15, DPU 1502 may perform at least one of: (1) a mapping of the set of VMs to the set of virtual queues, (2) a security check for an ability of each of the set of VMs to access a set of software registers, or (3) a mapping of each of the set of virtual queues to each of a set of control data paths. Further, step 1712 may be performed by display processor 127 in FIG. 1. In some aspects, each of the set of control data paths may include hardware that is used to perform a set of display processing operations. The set of display processing operations may include at least one of: fetching image data from a double data rate (DDR) memory; performing pixel processing; or communicating the pixel processing to a display panel. Also, performing the mapping of the set of VMs to the set of virtual queues may comprise: performing the mapping of the set of VMs to the set of virtual queues based on a mapping table for the mapping of the set of VMs to the set of virtual queues (e.g., VQ to VMID generation). In some aspects, performing the security check may comprise: performing the security check regarding whether each of the set of VMs is able to access the set of software registers (e.g., a memory protection unit (MPU) permission check).

At 1714, the DPU may determine whether access is granted for a configuration of software registers; and configure data for the software registers based on the access being granted, as described in connection with the examples in FIGS. 1-15. For example, as described in 1570 of FIG. 15, DPU 1502 may determine whether access is granted for a configuration of software registers; and configure data for the software registers based on the access being granted. Further, step 1714 may be performed by display processor 127 in FIG. 1. The data may include control information for data processing of a display processing unit (DPU).

At 1716, the DPU may determine whether the execution has reached a last workload in the set of workloads; and generate an interrupt for software based on the execution reaching the last workload, as described in connection with the examples in FIGS. 1-15. For example, as described in 1580 of FIG. 15, DPU 1502 may determine whether the execution has reached a last workload in the set of workloads; and generate an interrupt for software based on the execution reaching the last workload. Further, step 1716 may be performed by display processor 127 in FIG. 1. In some aspects, the interrupt may include information regarding which VM in the set of VMs triggered the generation of the interrupt.

At 1718, the DPU may generate a busy signal for each of the set of virtual queues and each of the set of control data paths; and map the busy signal for each of the set of virtual queues to the busy signal for each of the set of control data paths, as described in connection with the examples in FIGS. 1-15. For example, as described in 1582 of FIG. 15, DPU 1502 may generate a busy signal for each of the set of virtual queues and each of the set of control data paths; and map the busy signal for each of the set of virtual queues to the busy signal for each of the set of control data paths. Further, step 1718 may be performed by display processor 127 in FIG. 1. The DPU may also initiate each of a set of display processing operations based on the generation of the busy signal for each of the set of virtual queues and each of the set of control data paths.

At 1720, the DPU may output an indication of the performance at least one of: (1) the mapping of the set of VMs to the set of virtual queues, (2) the security check for the ability of each of the set of VMs to access the set of software registers, or (3) the mapping of each of the set of virtual queues to each of the set of control data paths, as described in connection with the examples in FIGS. 1-15. For example, as described in 1590 of FIG. 15, DPU 1502 may output an indication of the performance at least one of: (1) the mapping of the set of VMs to the set of virtual queues, (2) the security check for the ability of each of the set of VMs to access the set of software registers, or (3) the mapping of each of the set of virtual queues to each of the set of control data paths. Further, step 1720 may be performed by display processor 127 in FIG. 1. In some aspects, outputting the indication of the performance may comprise: transmitting the indication of the performance; or storing the indication of the performance.

In configurations, a method or an apparatus for display processing is provided. The apparatus may be a DPU (or other display processor), a CPU (or other central processor), a DPU driver, a DDIC, a GPU (or other graphics processor), an apparatus for display processing, a wireless communication device, and/or some other processor that may perform display processing. In aspects, the apparatus may be the display processor 127 within the device 104, or may be some other hardware within the device 104 or another device. The apparatus, e.g., display processor 127, may include means for configuring a virtualization component for a set of workloads associated with a set of virtual machines (VMs). The apparatus, e.g., display processor 127, may also include means for executing the set of workloads associated with the set of VMs for a set of virtual queues. The apparatus, e.g., display processor 127, may also include means for performing at least one of: (1) a mapping of the set of VMs to the set of virtual queues, (2) a security check for an ability of each of the set of VMs to access a set of software registers, or (3) a mapping of each of the set of virtual queues to each of a set of control data paths. The apparatus, e.g., display processor 127, may also include means for performing a security identifier (ID) check for each ID corresponding to each of the set of VMs, where the performance of the security ID check is based on the execution of the set of workloads. The apparatus, e.g., display processor 127, may also include means for communicating the at least one failure of the security ID check to software. The apparatus, e.g., display processor 127, may also include means for determining whether access is granted for a retrieval of register data for each of the set of workloads; and means for retrieving the register data for each of the set of workloads associated with the set of VMs based on the access being granted. The apparatus, e.g., display processor 127, may also include means for determining whether access is granted for a configuration of software registers; and means for configuring data for the software registers based on the access being granted. The apparatus, e.g., display processor 127, may also include means for determining whether the execution has reached a last workload in the set of workloads; and means for generating an interrupt for software based on the execution reaching the last workload. The apparatus, e.g., display processor 127, may also include means for generating a busy signal for each of the set of virtual queues and each of the set of control data paths; means for mapping the busy signal for each of the set of virtual queues to the busy signal for each of the set of control data paths; and means for initiating each of a set of display processing operations based on the generation of the busy signal for each of the set of virtual queues and each of the set of control data paths. The apparatus, e.g., display processor 127, may also include means for obtaining an indication of the set of workloads associated with the set of VMs; and means for storing the set of workloads associated with the set of VMs in the set of virtual queues. The apparatus, e.g., display processor 127, may also include means for obtaining an indication to start an execution of the set of workloads associated with the set of VMs for the set of virtual queues. The apparatus, e.g., display processor 127, may also include means for outputting an indication of the performance at least one of: (1) the mapping of the set of VMs to the set of virtual queues, (2) the security check for the ability of each of the set of VMs to access the set of software registers, or (3) the mapping of each of the set of virtual queues to each of the set of control data paths.

The subject matter described herein may be implemented to realize one or more benefits or advantages. For instance, the described display processing techniques may be used by a DPU (or other display processor), a CPU (or other central processor), a DPU driver, a DDIC, a GPU (or other graphics processor), an apparatus for display processing, a wireless communication device, or some other processor that may perform display processing to implement the virtualization acceleration techniques described herein. This may also be accomplished at a low cost compared to other display processing techniques. Moreover, the display processing techniques herein may improve or speed up data processing or execution. Further, the display processing techniques herein may improve resource or data utilization and/or resource efficiency. Additionally, aspects of the present disclosure may utilize virtualization acceleration techniques in order to improve memory bandwidth efficiency and/or increase processing speed at a DPU, a GPU, and/or a CPU.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

In accordance with this disclosure, the term “or” may be interpreted as “and/or” where context does not dictate otherwise. Additionally, while phrases such as “one or more” or “at least one” or the like may have been used for some features disclosed herein but not others, the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that may be accessed by one or more computers or one or more processors to retrieve instructions, code and/or data structures for implementation of the techniques described in this disclosure. By way of example, and not limitation, such computer-readable media may comprise RAM, ROM, EEPROM, CD-ROM or other optical disk storage, magnetic disk storage or other magnetic storage devices. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.
Aspect 1 is an apparatus for display processing, including at least one memory; and at least one processor coupled to the at least one memory and, based at least in part on information stored in the at least one memory, the at least one processor, individually or in any combination, is configured to: configure a virtualization component for a set of workloads associated with a set of virtual machines (VMs); execute the set of workloads associated with the set of VMs for a set of virtual queues; and perform at least one of: (1) a mapping of the set of VMs to the set of virtual queues, (2) a security check for an ability of each of the set of VMs to access a set of software registers, or (3) a mapping of each of the set of virtual queues to each of a set of control data paths.
Aspect 2 is the apparatus of aspect 1, wherein the at least one processor, individually or in any combination, is further configured to: perform a security identifier (ID) check for each ID corresponding to each of the set of VMs, wherein the performance of the security ID check is based on the execution of the set of workloads.
Aspect 3 is the apparatus of aspect 2, wherein to perform the security ID check, the at least one processor, individually or in any combination, is configured to: perform the security ID check at a memory management unit (MMU).
Aspect 4 is the apparatus of any of aspects 2 to 3, wherein the security ID check includes at least one failure, wherein the at least one processor, individually or in any combination, is further configured to: communicate the at least one failure of the security ID check to software.
Aspect 5 is the apparatus of any of aspects 1 to 4, wherein the at least one processor, individually or in any combination, is further configured to: determine whether access is granted for a retrieval of register data for each of the set of workloads; and retrieve the register data for each of the set of workloads associated with the set of VMs based on the access being granted.
Aspect 6 is the apparatus of aspect 5, wherein the register data includes information for configuring software registers at a display processing unit (DPU).
Aspect 7 is the apparatus of any of aspects 5 to 6, wherein the register data includes a virtual identifier (ID) associated with each of the set of virtual queues.
Aspect 8 is the apparatus of any of aspects 5 to 7, wherein to retrieve the register data, the at least one processor, individually or in any combination, is configured to: retrieve the register data from a double data rate (DDR) memory after a security identifier (ID) check.
Aspect 9 is the apparatus of any of aspects 1 to 8, wherein the at least one processor, individually or in any combination, is further configured to: determine whether access is granted for a configuration of software registers; and configure data for the software registers based on the access being granted.
Aspect 10 is the apparatus of aspect 9, wherein the data includes control information for data processing of a display processing unit (DPU).
Aspect 11 is the apparatus of any of aspects 1 to 10, wherein the at least one processor, individually or in any combination, is further configured to: determine whether the execution has reached a last workload in the set of workloads; and generate an interrupt for software based on the execution reaching the last workload.
Aspect 12 is the apparatus of aspect 11, wherein the interrupt includes information regarding which VM in the set of VMs triggered the generation of the interrupt.
Aspect 13 is the apparatus of any of aspects 1 to 12, wherein the at least one processor, individually or in any combination, is further configured to: generate a busy signal for each of the set of virtual queues and each of the set of control data paths; and map the busy signal for each of the set of virtual queues to the busy signal for each of the set of control data paths.
Aspect 14 is the apparatus of aspect 13, wherein the at least one processor, individually or in any combination, is further configured to: initiate each of a set of display processing operations based on the generation of the busy signal for each of the set of virtual queues and each of the set of control data paths.
Aspect 15 is the apparatus of any of aspects 1 to 14, wherein each of the set of control data paths includes hardware that is used to perform a set of display processing operations.
Aspect 16 is the apparatus of aspect 15, wherein the set of display processing operations includes at least one of: fetching image data from a double data rate (DDR) memory; performing pixel processing; or communicating the pixel processing to a display panel.
Aspect 17 is the apparatus of any of aspects 1 to 16, wherein to perform the mapping of the set of VMs to the set of virtual queues, the at least one processor, individually or in any combination, is configured to: perform the mapping of the set of VMs to the set of virtual queues based on a mapping table for the mapping of the set of VMs to the set of virtual queues.
Aspect 18 is the apparatus of any of aspects 1 to 17, wherein to perform the security check, the at least one processor, individually or in any combination, is further configured to: perform the security check regarding whether each of the set of VMs is able to access the set of software registers.
Aspect 19 is the apparatus of any of aspects 1 to 18, wherein to configure the virtualization component, the at least one processor, individually or in any combination, is further configured to: configure a mapping table for the mapping of the set of VMs to the set of virtual queues.
Aspect 20 is the apparatus of any of aspects 1 to 19, wherein to configure the virtualization component, the at least one processor, individually or in any combination, is configured to: configure the mapping for each of the set of virtual queues to each of the set of control data paths.
Aspect 21 is the apparatus of any of aspects 1 to 20, wherein the at least one processor, individually or in any combination, is further configured to: obtain an indication of the set of workloads associated with the set of VMs; and store the set of workloads associated with the set of VMs in the set of virtual queues.
Aspect 22 is the apparatus of any of aspects 1 to 21, wherein the at least one processor, individually or in any combination, is further configured to: obtain an indication to start an execution of the set of workloads associated with the set of VMs for the set of virtual queues.
Aspect 23 is the apparatus of any of aspects 1 to 22, wherein the at least one processor, individually or in any combination, is further configured to: output an indication of the performance at least one of: (1) the mapping of the set of VMs to the set of virtual queues, (2) the security check for the ability of each of the set of VMs to access the set of software registers, or (3) the mapping of each of the set of virtual queues to each of the set of control data paths.
Aspect 24 is the apparatus of any of aspects 1 to 23, wherein the apparatus is a wireless communication device, further comprising at least one of a transceiver or an antenna coupled to the at least one processor, wherein to output the indication of the performance, the at least one processor, individually or in any combination, is configured to: transmit, via at least one of the transceiver or the antenna, the indication of the performance; or store the indication of the performance.
Aspect 25 is a method of display processing for implementing any of aspects 1 to 24.
Aspect 26 is an apparatus for display processing including means for implementing any of aspects 1 to 24.
Aspect 27 is a computer-readable medium (e.g., a non-transitory computer-readable medium) storing computer executable code, the code when executed by at least one processor causes the at least one processor to implement any of aspects 1 to 24.

What is claimed is:

1. An apparatus for display processing, comprising:
at least one memory; and
at least one processor coupled to the at least one memory and, based at least in part on information stored in the at least one memory, the at least one processor, individually or in any combination, is configured to:
configure a virtualization component for a set of workloads associated with a set of virtual machines (VMs);
execute the set of workloads associated with the set of VMs for a set of virtual queues; and
perform at least one of: (1) a mapping of the set of VMs to the set of virtual queues, (2) a security check for an ability of each of the set of VMs to access a set of software registers, or (3) a mapping of each of the set of virtual queues to each of a set of control data paths.

2. The apparatus of claim 1, wherein the at least one processor, individually or in any combination, is further configured to:
perform a security identifier (ID) check for each ID corresponding to each of the set of VMs, wherein the performance of the security ID check is based on the execution of the set of workloads.

3. The apparatus of claim 2, wherein to perform the security ID check, the at least one processor, individually or in any combination, is configured to: perform the security ID check at a memory management unit (MMU).

4. The apparatus of claim 2, wherein the security ID check includes at least one failure, wherein the at least one processor, individually or in any combination, is further configured to:
communicate the at least one failure of the security ID check to software.

5. The apparatus of claim 1, wherein the at least one processor, individually or in any combination, is further configured to:
determine whether access is granted for a retrieval of register data for each of the set of workloads; and
retrieve the register data for each of the set of workloads associated with the set of VMs based on the access being granted.

6. The apparatus of claim 5, wherein the register data includes information for configuring software registers at a display processing unit (DPU).

7. The apparatus of claim 5, wherein the register data includes a virtual identifier (ID) associated with each of the set of virtual queues.

8. The apparatus of claim 5, wherein to retrieve the register data, the at least one processor, individually or in any combination, is configured to: retrieve the register data from a double data rate (DDR) memory after a security identifier (ID) check.

9. The apparatus of claim 1, wherein the at least one processor, individually or in any combination, is further configured to:
determine whether access is granted for a configuration of software registers; and
configure data for the software registers based on the access being granted, wherein the data includes control information for data processing of a display processing unit (DPU).

10. The apparatus of claim 1, wherein the at least one processor, individually or in any combination, is further configured to:
determine whether the execution has reached a last workload in the set of workloads; and
generate an interrupt for software based on the execution reaching the last workload, wherein the interrupt includes information regarding which VM in the set of VMs triggered the generation of the interrupt.

11. The apparatus of claim 1, wherein the at least one processor, individually or in any combination, is further configured to:
generate a busy signal for each of the set of virtual queues and each of the set of control data paths; and
map the busy signal for each of the set of virtual queues to the busy signal for each of the set of control data paths.

12. The apparatus of claim 11, wherein the at least one processor, individually or in any combination, is further configured to:
initiate each of a set of display processing operations based on the generation of the busy signal for each of the set of virtual queues and each of the set of control data paths.

13. The apparatus of claim 1, wherein each of the set of control data paths includes hardware that is used to perform a set of display processing operations, wherein the set of display processing operations includes at least one of:
fetching image data from a double data rate (DDR) memory;
performing pixel processing; or
communicating the pixel processing to a display panel.

14. The apparatus of claim 1, wherein to perform the mapping of the set of VMs to the set of virtual queues, the at least one processor, individually or in any combination, is configured to:
perform the mapping of the set of VMs to the set of virtual queues based on a mapping table for the mapping of the set of VMs to the set of virtual queues.

15. The apparatus of claim 1, wherein to perform the security check, the at least one processor, individually or in any combination, is further configured to:
perform the security check regarding whether each of the set of VMs is able to access the set of software registers.

16. The apparatus of claim 1, wherein to configure the virtualization component, the at least one processor, individually or in any combination, is further configured to: configure a mapping table for the mapping of the set of VMs to the set of virtual queues; or
wherein to configure the virtualization component, the at least one processor, individually or in any combination, is configured to: configure the mapping for each of the set of virtual queues to each of the set of control data paths.

17. The apparatus of claim 1, wherein the at least one processor, individually or in any combination, is further configured to:
obtain an indication of the set of workloads associated with the set of VMs;
store the set of workloads associated with the set of VMs in the set of virtual queues; and
obtain an indication to start an execution of the set of workloads associated with the set of VMs for the set of virtual queues.

18. The apparatus of claim 1, wherein the at least one processor, individually or in any combination, is further configured to:
output an indication of the performance at least one of: (1) the mapping of the set of VMs to the set of virtual queues, (2) the security check for the ability of each of the set of VMs to access the set of software registers, or (3) the mapping of each of the set of virtual queues to each of the set of control data paths, wherein to output the indication of the performance, the at least one processor, individually or in any combination, is configured to:
transmit the indication of the performance; or
store the indication of the performance.

19. A method of display processing, comprising:
configuring a virtualization component for a set of workloads associated with a set of virtual machines (VMs);
executing the set of workloads associated with the set of VMs for a set of virtual queues; and
performing at least one of: (1) a mapping of the set of VMs to the set of virtual queues, (2) a security check for an ability of each of the set of VMs to access a set of software registers, or (3) a mapping of each of the set of virtual queues to each of a set of control data paths.

20. A computer-readable medium storing computer executable code for display processing, the code when executed by at least one processor causes the at least one processor to:
configure a virtualization component for a set of workloads associated with a set of virtual machines (VMs);
execute the set of workloads associated with the set of VMs for a set of virtual queues; and
perform at least one of: (1) a mapping of the set of VMs to the set of virtual queues, (2) a security check for an ability of each of the set of VMs to access a set of software registers, or (3) a mapping of each of the set of virtual queues to each of a set of control data paths.
